(19) United States
(12) Patent Application Publication
(10) Pub. No.: US 2026/0169573 A1
(43) Pub. Date: Jun. 18, 2026

(54) METHOD AND APPARATUS FOR REMOVING VIBRATION SIGNAL FOR GESTURE RECOGNITION

(71) Applicant: Samsung Electronics Co., Ltd., Suwon-si (KR)

(72) Inventors: Wonsuk CHUNG, Suwon-si (KR); Yongsang CHO, Suwon-si (KR); Youjin KIM, Suwon-si (KR); Cheolo KIM, Suwon-si (KR); Sungjin PARK, Suwon-si (KR); Jinyoup AHN, Suwon-si (KR); Byungwook YOO, Suwon-si (KR)

(21) Appl. No.: 19/535,766

(22) Filed: Feb. 10, 2026

Related U.S. Application Data
(63) Continuation of application No. PCT/KR2024/012402, filed on Aug. 21, 2024.

(30) Foreign Application Priority Data
Sep. 21, 2023 (KR) 10-2023-0126321
Oct. 11, 2023 (KR) 10-2023-0135106
Oct. 17, 2023 (KR) 10-2023-0138416
Aug. 9, 2024 (KR) 10-2024-0106954

(51) Int. Cl. G06F 3/01; G04G 21/02; G06F 3/0346; G06F 3/038

(52) U.S. Cl. CPC G06F 3/017; G04G 21/02; G06F 3/016; G06F 3/0346; G06F 3/038

(57) ABSTRACT

An electronic device may remove a vibration signal from a sensor signal including a gesture signal and the vibration signal. The electronic device includes: an actuator generating vibration; a plurality of sensors including a first sensor and a second sensor recognizing a gesture; a memory storing instructions; and at least one processor operatively connected to the actuator, the plurality of sensors, and the memory, wherein the instructions, when executed by the processor(s), may cause the electronic device to: suppress and/or reduce a component of a first frequency in a first signal based on the first frequency matching a vibration frequency range corresponding to the actuator; and recognize a first gesture based on at least the processed first signal and a second signal acquired from the second sensor, from among a plurality of signals acquired from the plurality of sensors.

### CROSS-REFERENCE TO RELATED APPLICATIONS

This application is a continuation of International Application No. PCT/KR2024/012402 designating the United States, filed on Aug. 21, 2024, in the Korean Intellectual Property Receiving Office and claiming priority to Korean Patent Application Nos. 10-2023-0126321, filed on Sep. 21, 2023, 10-2023-0135106, filed on Oct. 11, 2023, 10-2023-0138416, filed on Oct. 17, 2023, and 10-2024-0106954, filed on Aug. 9, 2024, in the Korean Intellectual Property Office, the disclosures of each of which are incorporated by reference herein in their entireties.

### BACKGROUND

### Field

The disclosure relates to a method of removing a vibration signal in order to improve gesture recognition performance in an electronic device.

### Description of Related Art

Among user interface technologies, a gesture recognition technology may be broadly divided into a technology for recognizing a gesture through an image using an image sensor and a technology for recognizing a gesture using sensors other than the image sensor (e.g., inertial measurement units (IMUs) such as a linear acceleration sensor or a gyro sensor). The technology for recognizing a gesture using sensors other than the image sensor has the advantage of greater freedom than the technology for recognizing a gesture using the image sensor because it may be used anytime and anywhere.

### SUMMARY

An electronic device according to an example embodiment may include: an actuator configured to generate vibration, a plurality of sensors including a first sensor and a second sensor configured to recognize a gesture of a user of the electronic device, a memory configured to store instructions; and at least one processor, comprising processing circuitry, operatively connected to the actuator, the plurality of sensors, and the memory, wherein at least one processor, individually and/or collectively, may be configured to execute the instructions and to cause the electronic device to: based on a first frequency, at which vibration is generated in a first signal obtained from the first sensor matching a vibration frequency range corresponding to the actuator, suppress and/or reduce a component of the first frequency in the first signal, and recognize a first gesture based on at least the processed first signal and a second signal obtained from the second sensor among a plurality of signals obtained from the plurality of sensors.

A method performed by an electronic device according to an example embodiment may include: based on a first frequency, at which vibration is generated in a first signal obtained from a first sensor matching a vibration frequency range corresponding to the actuator, suppressing and/or reducing the first signal, and recognizing a first gesture based on at least the processed first signal and a second signal obtained from a second sensor among a plurality of signals obtained from a plurality of sensors including the first sensor and the second sensor.

The electronic device may perform classification of gesture signals based on gestures performed by a user. However, since a vibration signal generated by vibration of the electronic device and a gesture signal generated by a gesture performed by the user may overlap, there may be a problem in which the electronic device does not recognize the gesture signal or the classification of the gesture signal is incorrect. A decrease in a recognition rate of gestures of the user may cause significant inconvenience in the usability of the electronic device. In the related art, in order to prevent/reduce the decrease in the recognition rate of gestures of the user, the vibration is set to be short and weak, or the user is required to perform clear and large gestures. However, this method clearly has the disadvantage of limiting an increase in usability of the electronic device.

On the other hand, an electronic device according to various example embodiments may obtain a frequency, at which vibration is generated, by monitoring a sensor signal obtained through a sensor in a frequency domain, and downscale a signal adjacent to the obtained vibration frequency. Through this method, it is possible to increase the usability of the electronic device while preventing/reducing the decrease in the recognition rate of gestures of the user.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example configuration of an electronic device according to various embodiments.

FIGS. 2A and 2B are front and rear perspective views, respectively, of an example electronic device according to various embodiments.

FIG. 3 is an exploded perspective view of an electronic device according to various embodiments.

FIG. 4 is a diagram illustrating different actuators configured to generating vibration of vibration frequency ranges included in an electronic device, and signals recognized by a sensing module by vibrations generated by the different actuators according to various embodiments.

FIG. 5 is a flowchart illustrating an example method of processing a vibration signal by monitoring a signal obtained through a sensor in a frequency domain by an electronic device according to various embodiments.

FIG. 6 is a diagram illustrating an example method of suppressing a vibration signal by monitoring a gesture signal of a user and a vibration signal in a frequency domain by an electronic device according to various embodiments.

FIG. 7 is a flowchart illustrating an example method of suppressing a vibration signal by monitoring a gesture signal of a user and a vibration signal in a frequency domain by an electronic device according to various embodiments.

FIG. 8 is a diagram illustrating an example method of suppressing or reducing a vibration signal based on a pattern of a sensor signal that does not detect a vibration signal by an electronic device according to various embodiments.

FIGS. 9, 10 and 11 are diagrams illustrating example configurations of a gesture recognition module included in an electronic device that suppresses or reduces a vibration signal based on an envelope signal according to various embodiments.

FIG. 12 is a diagram illustrating an example configuration of a gesture recognition module of an electronic device performing a method of monitoring a vibration frequency together with a method of suppressing or reducing a vibration signal based on an envelope signal according to various embodiments.

FIG. 13 is a flowchart illustrating an example method of processing a vibration signal included in a vibration section by an electronic device according to various embodiments.

FIG. 14 is a diagram illustrating an example process of recognizing a gesture of a user by an electronic device according to various embodiments.

FIGS. 15A and 15B are diagrams illustrating an example scenario in which a gesture signal and a vibration signal overlap in a sensor signal detected in an electronic device according to various embodiments.

FIG. 16 is a diagram including graphs illustrating an example process of calculating a vibration section based on vibration information according to vibration by an electronic device according to various embodiments.

FIG. 17 includes graphs illustrating sensor signals that appear when vibration in an electronic device and a gesture of a user occur adjacent to each other according to various embodiments.

FIG. 18 is a flowchart illustrating an example process of setting an expected vibration section based on vibration information and calculating a vibration section within the expected vibration section by an electronic device according to various embodiments.

FIG. 19 is a diagram illustrating an example process of changing time taken from a time point at which an electronic device recognizes a gesture based on a user input to a time point at which the electronic device generates vibration according to recognition of the gesture according to various embodiments.

FIGS. 20 and 21 are a flowchart and graphs illustrating an example process of calculating a boundary time point of a vibration signal and a gesture signal within an expected vibration section by an electronic device according to various embodiments.

FIG. 22 is a block diagram illustrating an example configuration of a gesture recognition module of an electronic device according to various embodiments.

FIG. 23 is a diagram illustrating an example process in which an electronic device passively processes a vibration signal to prevent/reduce misclassification according to various embodiments.

### DETAILED DESCRIPTION

Hereinafter, various example embodiments will be described in greater detail with reference to the accompanying drawings. When describing the example embodiments with reference to the accompanying drawings, like reference numerals refer to like elements and any repeated description related thereto may not be provided.

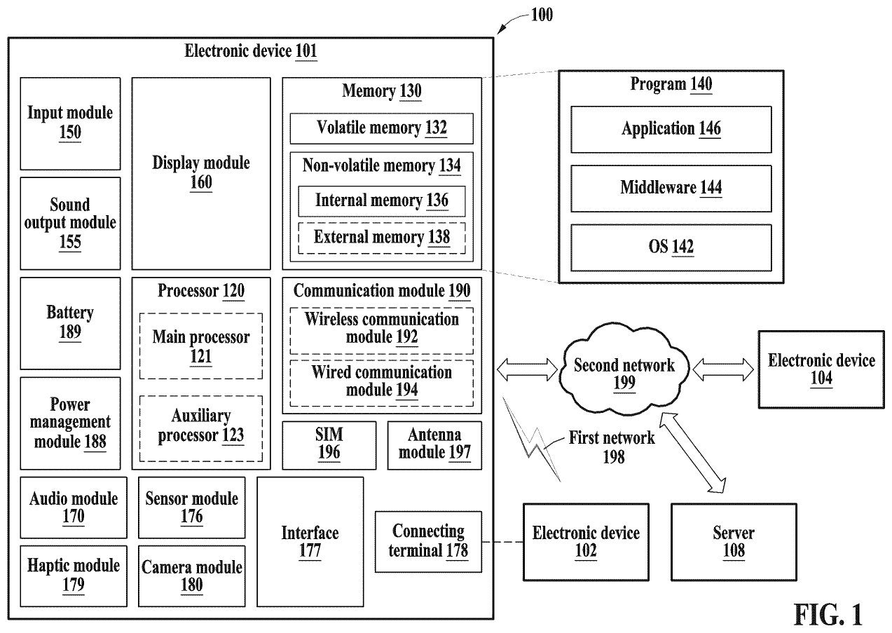

FIG. 1 is a block diagram illustrating an example electronic device 101 in a network environment 100 according to various embodiments. Referring to FIG. 1, the electronic device 101 in the network environment 100 may communicate with an electronic device 102 via a first network 198 (e.g., a short-range wireless communication network), or communicate with an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, a memory 130, an input module 150, a sound output module 155, a display module 160, an audio module 170, and a sensor module 176, an interface 177, a connecting terminal 178, a haptic module 179, a camera module 180, a power management module 188, a battery 189, a communication module 190, a subscriber identification module (SIM) 196, or an antenna module 197. In various embodiments, at least one of the components (e.g., the connecting terminal 178) may be omitted from the electronic device 101, or one or more other components may be added in the electronic device 101. In various embodiments, some of the components (e.g., the sensor module 176, the camera module 180, or the antenna module 197) may be integrated as a single component (e.g., the display module 160).

The processor 120 may execute, for example, software (e.g., a program 140) to control at least one other component (e.g., a hardware or software component) of the electronic device 101 connected to the processor 120, and may perform various data processing or computation. According to an embodiment, as at least a part of data processing or computation, the processor 120 may store a command or data received from another component (e.g., the sensor module 176 or the communication module 190) in a volatile memory 132, process the command or the data stored in the volatile memory 132, and store resulting data in a non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with the main processor 121. For example, when the electronic device 101 includes the main processor 121 and the auxiliary processor 123, the auxiliary processor 123 may be adapted to consume less power than the main processor 121 or to be specific to a specified function. The auxiliary processor 123 may be implemented separately from the main processor 121 or as a part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one (e.g., the display module 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an ISP or a CP) may be implemented as a portion of another component (e.g., the camera module 180 or the communication module 190) that is functionally related to the auxiliary processor 123. According to an embodiment, the auxiliary processor 123 (e.g., an NPU) may include a hardware structure specified for processing of an artificial intelligence (AI) model. An artificial intelligence model may be generated through machine learning. Such learning may be performed by, for example, the electronic device 101 in which artificial intelligence is performed, or performed via a separate server (e.g., the server 108). Learning algorithms may include, but are not limited to, for example, supervised learning, unsupervised learning, semi-supervised learning, or reinforcement learning. The AI model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), and a bidirectional recurrent deep neural network (BRDNN), a deep Q-network, or a combination of two or more thereof, but is not limited thereto. The AI model may additionally or alternatively include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored as software in the memory 130, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output a sound signal to the outside of the electronic device 101. The sound output module 155 may include, for example, a speaker or a receiver. The speaker may be used for general purposes, such as playing multimedia or playing record. The receiver may be used to receive an incoming call. According to an embodiment, the receiver may be implemented separately from the speaker or as a part of the speaker.

The display module 160 may visually provide information to the outside (e.g., a user) of the electronic device 101. The display module 160 may include, for example, a display, a hologram device, or a projector and control circuitry to control a corresponding one of the display, the hologram device, and the projector. According to an embodiment, the display module 160 may include a touch sensor adapted to detect a touch, or a pressure sensor adapted to measure the intensity of force incurred by the touch.

The audio module 170 may convert a sound into an electric signal or vice versa. According to an embodiment, the audio module 170 may obtain the sound via the input module 150, or output the sound via the sound output module 155 or an external electronic device (e.g., the electronic device 102 such as a speaker or a headphone) directly or wirelessly connected to the electronic device 101.

The sensor module 176 may detect an operational state (e.g., power or temperature) of the electronic device 101 or an environmental state (e.g., a state of a user) external to the electronic device 101, and generate an electric signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., by wire) or wirelessly. According to an embodiment, the interface 177 may include, for example, a high-definition multimedia interface (HDMI), a universal serial bus (USB) interface, a secure digital (SD) card interface, or an audio interface.

The connecting terminal 178 may include a connector via which the electronic device 101 may be physically connected to an external electronic device (e.g., the electronic device 102). According to an embodiment, the connecting terminal 178 may include, for example, an HDMI connector, a USB connector, an SD card connector, or an audio connector (e.g., a headphone connector).

The haptic module 179 may convert an electric signal into a mechanical stimulus (e.g., vibration or a movement) or an electrical stimulus which may be recognized by a user via his or her tactile sensation or kinesthetic sensation. According to an embodiment, the haptic module 179 may include, for example, a motor, a piezoelectric element, an actuator, or an electric stimulator.

The camera module 180 may capture a still image and moving images. According to an embodiment, the camera module 180 may include one or more lenses, image sensors, image signal processors, or flashes.

The power management module 188 may manage power supplied to the electronic device 101. According to an embodiment, the power management module 188 may be implemented as, for example, at least a part of a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more CPs that are operable independently of the processor 120 (e.g., an AP) and that support a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module, or a power line communication (PLC) module). A corresponding one of these communication modules may communicate with the external electronic device 104 via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., a LAN or a wide area network (WAN))). These various types of communication modules may be implemented as a single component (e.g., a single chip), or may be implemented as multiple components (e.g., multiple chips) separate from each other. The wireless communication module 192 may identify and authenticate the electronic device 101 in a communication network, such as the first network 198 or the second network 199, using subscriber information (e.g., international mobile subscriber identity (IMSI)) stored in the SIM 196.

The wireless communication module 192 may support a 5G network after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., a mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), an array antenna, analog beam-forming, or a large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the audio signal processing apparatus 101. According to an embodiment, the antenna module 197 may include an antenna including a radiating element including a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in a communication network, such as the first network 198 or the second network 199, may be selected by, for example, the communication module 190 from the plurality of antennas. The signal or the power may be transmitted or received between the communication module 190 and the external electronic device via the at least one selected antenna. According to various embodiments, another component (e.g., a radio frequency integrated circuit (RFIC)) other than the radiating element may be additionally formed as a part of the antenna module 197.

According to embodiments, the antenna module 197 may form a mmWave antenna module. According to an embodiment, the mmWave antenna module may include a PCB, an RFIC disposed on a first surface (e.g., a bottom surface) of the PCB or adjacent to the first surface and capable of supporting a designated a high-frequency band (e.g., the mmWave band), and a plurality of antennas (e.g., array antennas) disposed on a second surface (e.g., a top or a side surface) of the PCB, or adjacent to the second surface and capable of transmitting or receiving signals in the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the external electronic devices 102 or 104 may be a device of the same type as or a different type from the electronic device 101. According to an embodiment, all or some of operations to be executed by the electronic device 101 may be executed at one or more external electronic devices (e.g., the external devices 102 and 104, and the server 108). For example, if the electronic device 101 needs to perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and may transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

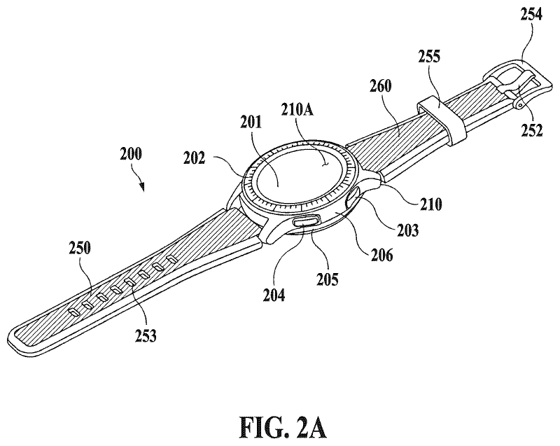

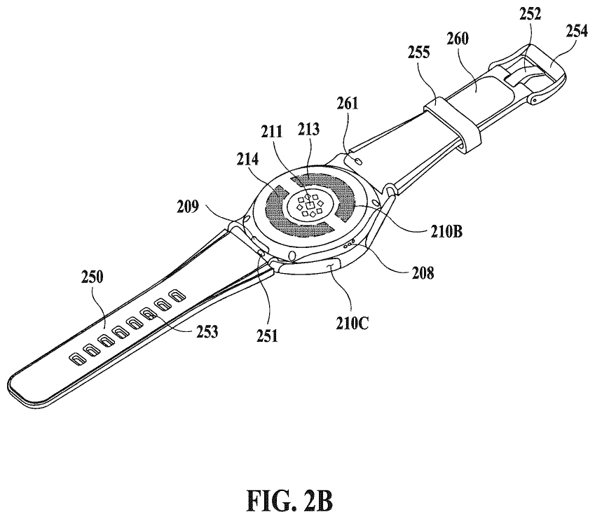

FIGS. 2A and 2B are front and rear perspective views, respectively, illustrating an example electronic device according to various embodiments.

Referring to FIGS. 2A and 2B, according to various embodiments, an electronic device 200 (e.g., the electronic device 101 of FIG. 1) may include a housing 210 including a first surface (or a front surface) 210A, a second surface (or a rear surface) 210B, and a side surface 210C surrounding a space between the first surface 210A and the second surface 210B, and fastening members 250 and 260 connected to at least a portion of the housing 210 and configured to detachably attach the electronic device 200 to a body part (e.g., a wrist, an ankle, etc.) of a user. In an embodiment (not shown), the housing may also refer to a structure which forms a portion of the first surface 210A, the second surface 210B, and the side surface 210C of FIGS. 2A and 2B. According to an embodiment, the first surface 210A may be formed by a front plate 201 (e.g., a glass plate or a polymer plate including various coating layers) of which at least a portion is substantially transparent. The second surface 210B may be formed by a rear plate 207 that is substantially opaque. The rear plate 207 may be formed of, for example, coated or colored glass, ceramic, polymer, metal (e.g., aluminum, stainless steel (SS), or magnesium), or a combination of at least two thereof. The side surface 210C may be coupled to the front plate 201 and the rear plate 207 and may be formed by a side bezel structure (or a “side member”) 206 including a metal and/or a polymer. In various embodiments, the rear plate 207 and the side bezel structure 206 may be integrally formed and may include the same material (e.g., a metal material such as aluminum). The fastening members 250 and 260 may be formed of various materials and may have various shapes. For example, the fastening members 250 and 260 may be formed of woven fabric, leather, rubber, urethane, metal, ceramic, or a combination of at least two of the aforementioned materials and may be implemented in an integrated form or with a plurality of unit links that are movable relative to each other.

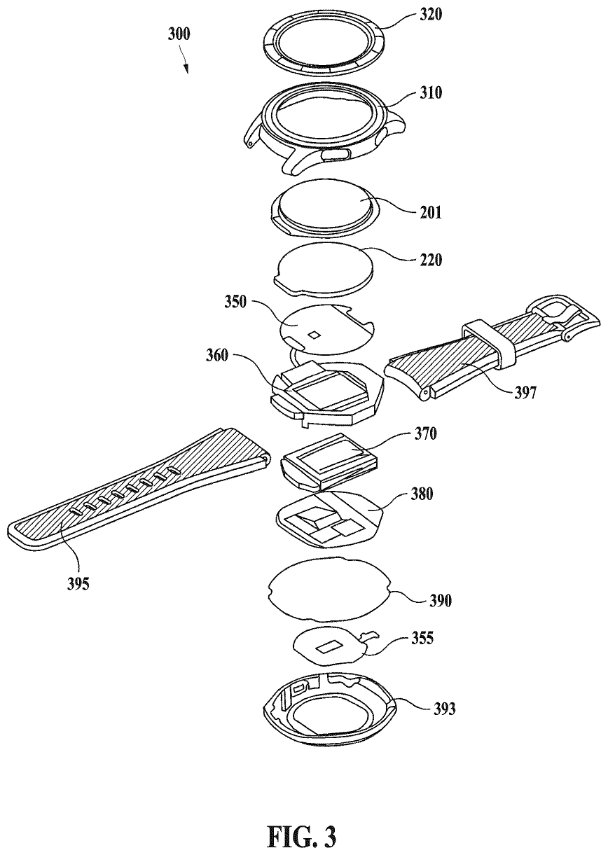

According to an embodiment, the electronic device 200 may include at least one of a display 220 (refer to FIG. 3), audio modules 205 and 208, a sensor module 211, key input devices 202, 203, and 204, and a connector hole 209. In various embodiments, the electronic device 200 may not include at least one (e.g., the key input devices 202, 203, and 204, the connector hole 209, or the sensor module 211) of the components, or additionally include other components.

The display 220 may be visible through a considerable portion of the front plate 201, for example. The display 220 may have a shape corresponding to the shape of the front plate 201 or may have various shapes, such as a circle, an oval, or a polygon. The display 220 may be coupled to or disposed adjacent to a touch sensing circuit, a pressure sensor capable of measuring an intensity (or pressure) of a touch, and/or a fingerprint sensor.

The audio modules 205 and 208 may include a microphone hole 205 and a speaker hole 208. A microphone for acquiring an external sound may be disposed in the microphone hole 205. In various embodiments, a plurality of microphones may be disposed to detect a direction of a sound. The speaker hole 208 may be used as an external speaker and a call receiver for calls. In various embodiments, the speaker hole 208 and the microphone hole 205 may be implemented as a single hole, or a speaker (e.g., a piezo speaker) may be included without the speaker hole 208.

The sensor module 211 may generate an electrical signal or a data value corresponding to an internal operating state of the electronic device 200 or an external environmental state. The sensor module 211 may include, for example, a biometric sensor module 211 (e.g., a heart rate monitor (HRM) sensor) disposed on the second surface 210B of the housing 210. The electronic device 200 may further include at least one of sensor modules (not shown), for example, a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor.

The sensor module 211 may include electrode areas 213 and 214 that form a portion of the surface of the electronic device 200 and a biosignal detection circuit (not shown) electrically connected to the electrode areas 213 and 214. For example, the electrode areas 213 and 214 may include a first electrode area 213 and a second electrode area 214 disposed on the second surface 210B of the housing 210. The sensor module 211 may be configured such that the electrode areas 213 and 214 obtain an electrical signal from a body part of the user, and the biosignal detection circuit detects biometric information of the user based on the electrical signal.

The key input devices 202, 203, and 204 may include a wheel key 202 disposed on the first surface 210A of the housing 210 and rotatable in at least one direction, and/or side key buttons 203 and 204 disposed on the side surface 210C of the housing 210. The wheel key may have a shape corresponding to the shape of the front plate 201. In an embodiment, the electronic device 200 may not include some or all of the above-described key input devices 202, 203, and 204, and the key input devices 202, 203, and 204 that are not included may be implemented in other forms such as soft keys on the display 220. The connector hole 209 may include another connector hole (not shown) that accommodates a connector (e.g., a USB connector) for transmitting and receiving power and/or data to and from an external electronic device and accommodates a connector for transmitting and receiving an audio signal to and from an external electronic device. The electronic device 200 may further include, for example, a connector cover (not shown) that covers at least a portion of the connector hole 209 and blocks infiltration of external foreign materials into the connector hole.

The fastening members 250 and 260 may be detachably fastened to at least a partial area of the housing 210 using locking members 251 and 261. The fastening members 250 and 260 may include one or more of a fixing member 252, a fixing member fastening hole 253, a band guide member 254, and a band fixing ring 255.

The fixing member 252 may be configured to fix the housing 210 and the fastening members 250 and 260 to a part (e.g., a wrist, an ankle, etc.) of the user's body. The fixing member fastening hole 253 may correspond to the fixing member 252 to fix the housing 210 and the fastening members 250 and 260 to the part of the user's body. The band guide member 254 may be configured to limit a range of a movement of the fixing member 252 when the fixing member 252 is fastened to the fixing member fastening hole 253, so that the fastening members 250 and 260 may be fastened to the part of the user's body in a state of being brought into close contact with the part of the user's body. The band fixing ring 255 may limit a range of a movement of the fastening member 250, 260 in a state in which the fixing member 252 and the fixing member fastening hole 253 are fastened with each other.

FIG. 3 is an exploded perspective view of an electronic device according to various embodiments.

Referring to FIG. 3, an electronic device 300 (e.g., the electronic device 101 of FIG. 1 or the electronic device 200 of FIG. 2A) may include a side bezel structure 310, a wheel key 320, a front plate 201, a display 220, a first antenna 350, a second antenna 355, a support member 360 (e.g., a bracket), a battery 370, a PCB 380, a sealing member 390, a rear plate 393, and fastening members 395 and 397. At least one of the components of the electronic device 300 may be the same as or similar to at least one of the components of the electronic device 101 of FIG. 1 or the electronic device 200 of FIG. 2A, and a repeated description thereof will be omitted hereinafter. The support member 360 may be disposed inside the electronic device 300 and connected to the side bezel structure 310, or may be integrally formed with the side bezel structure 310. The support member 360 may be formed of, for example, a metal material and/or a non-metal material (e.g., polymer). The display 220 may be connected to one surface of the support member 360, and the PCB 380 may be connected to another surface of the support member 360. The PCB 380 may be provided with a processor, a memory, and/or an interface mounted thereon. The processor may include, for example, one or more of a CPU, a GPU, an AP, a sensor processor, or a CP. The memory may include, for example, a volatile memory or a non-volatile memory. The interface may include, for example, a high-definition multimedia interface (HDMI), a USB interface, a secure digital (SD) card interface, or an audio interface. For example, the interface may electrically or physically connect the electronic device 300 to an external electronic device, and may include a USB connector, an SD card/multimedia card (MMC) connector, or an audio connector.

The battery 370, which is a device for supplying power to at least one component of the electronic device 300, may include, for example, a non-rechargeable primary battery, a rechargeable secondary battery, or a fuel cell. For example, at least a portion of the battery 370 may be disposed on substantially the same plane as the PCB 380. The battery 370 may be disposed integrally inside the electronic device 200, or disposed detachably from the electronic device 200.

The first antenna 350 may be disposed between the display 220 and the support member 360. The first antenna 350 may include, for example, a near-field communication (NFC) antenna, a wireless charging antenna, and/or a magnetic secure transmission (MST) antenna. For example, the first antenna 350 may perform short-range communication with an external device, wirelessly transmit and receive power used for charging, or transmit a magnetism-based signal including a short-range communication signal or payment data. In an embodiment, an antenna structure may be formed by a portion of the side bezel structure 310 and/or the support member 360, or a combination thereof.

The second antenna 355 may be disposed between the PCB 380 and the rear plate 393. The second antenna 355 may include, for example, an NFC antenna, a wireless charging antenna, and/or an MST antenna. For example, the second antenna 355 may perform short-range communication with an external device, wirelessly transmit and receive power used for charging, or transmit a magnetism-based signal including a short-range communication signal or payment data. In an embodiment, an antenna structure may be formed by a portion of the side bezel structure 310 and/or the rear plate 393, or a combination thereof.

The sealing member 390 may be disposed between the side bezel structure 310 and the rear plate 393. The sealing member 390 may be configured to prevent and/or reduce moisture and foreign materials from being introduced into a space surrounded by the side bezel structure 310 and the rear plate 393 from the outside.

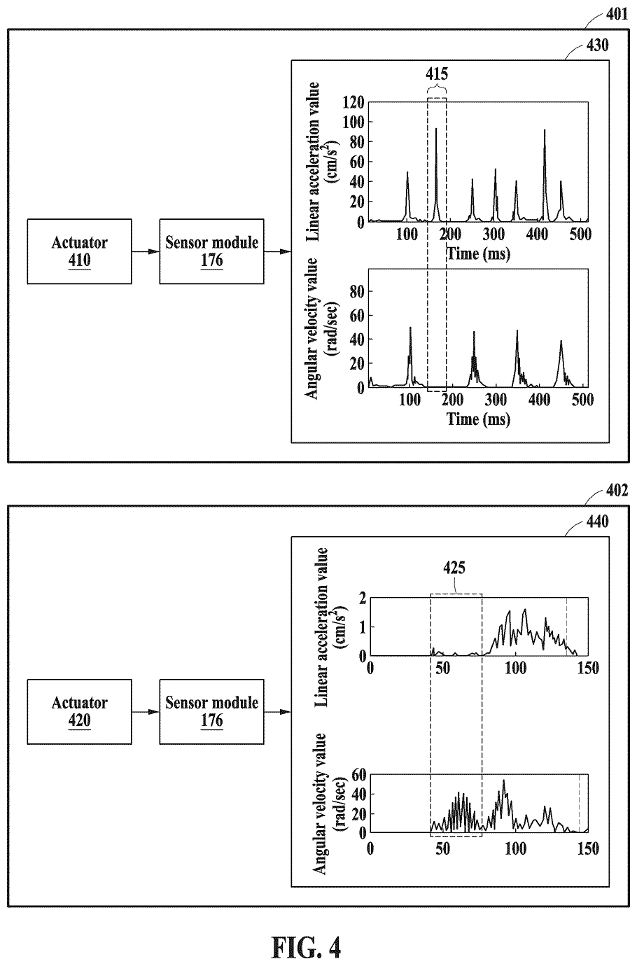

FIG. 4 is a diagram including graphs illustrating different actuators and signals obtained by a sensing module by vibrations generated by the different actuators according to various embodiments.

In an embodiment, an electronic device (e.g., the electronic device 101 of FIG. 1, the electronic device 200 of FIG. 2A, or the electronic device 300 of FIG. 3) may be a wearable device that is detachable from a part of a user's body (e.g., a wrist). When an event occurs, the electronic device may provide a user with haptic feedback corresponding to the event. For example, the electronic device may generate vibration corresponding to the event. For example, the electronic device may generate vibration according to an alarm for an event occurring therein (e.g., an incoming call, receiving a text message, or receiving an instant message). In another example, the electronic device may generate vibration feedback corresponding to a gesture of the user. For example, when the electronic device has an incoming call, the user wearing the electronic device may perform a gesture (e.g., clenching a first and opening a hand) to answer the call. When the electronic device successfully recognizes the gesture of the user, the electronic device may generate vibration feedback corresponding to the successful recognition of the gesture.

According to an embodiment, the electronic device may include an actuator 410. In another example, the electronic device may include an actuator 420. For example, the actuator 410 and the actuator 420 may represent different vibration motors, respectively. For example, the actuator 410 may generate physically linear vibration. In another example, the actuator 420 may generate physically circular vibration. In other words, the vibration generated by the actuator 410 and the vibration generated by the actuator 420 may each have a physical shaking direction. A vibration frequency range of the vibration generated by the actuator 410 and a vibration frequency range of the vibration generated by the actuator 420 may be different from each other. For example, a vibration frequency of the vibration generated by the actuator 410 may be 180 Hz. In another example, a vibration frequency of the vibration generated by the actuator 420 may be 110 Hz. For example, a signal sensed by the sensor module 176 in a first case 401 where the actuator 410 is mounted on the electronic device may be different from a signal sensed by the sensor module 176 in a second case 402 where the actuator 420 is mounted on the electronic device.

Hereinafter, the first case 401 where the actuator 410 is mounted on the electronic device and the second case 402 where the actuator 420 is mounted on the electronic device will be described separately. The description focuses on a case where the vibration frequency of the vibration signal generated by the actuator 410 is higher than the vibration frequency generated by the actuator 420.

The sensor module 176 may sense signals (e.g., an acceleration signal and/or an angular velocity signal) generated due to a movement of the electronic device. The movement of the electronic device may be caused by an element (e.g., the actuator 410 or the actuator 420) inside the electronic device or by a gesture of the user. In this disclosure, a signal generated by a gesture of the user may be referred to as a gesture signal. For example, the gesture signal may include a signal corresponding to an acceleration applied to the electronic device due to the gesture (e.g., an acceleration signal) and/or a signal corresponding to an angular velocity (e.g., an angular velocity signal). Gesture recognition is used in a variety of applications. For example, when a phone call comes in, the user wearing the electronic device may perform a gesture of clenching a first and opening a hand to answer the call. When the user performs the gesture of clenching the first and opening the hand, a microscopic movement may occur in the electronic device, and the sensor module 176 may detect a gesture signal corresponding to the movement. For example, the sensor module 176 may detect changes in an acceleration and/or an angular velocity that occur in the electronic device as the user performs a gesture of clenching the first and opening the hand.

In the first case 401, the sensor module 176 may detect a vibration signal generated by the actuator 410. However, when the gesture signal generated based on the gesture of the user and the vibration signal generated by the actuator 410 overlap, the electronic device may fail to recognize the gesture. Similarly, in the second case 402, the sensor module 176 may detect the vibration signal generated by the actuator 420, however, when the gesture signal of the user and the vibration signal generated by the actuator 420 overlap, the electronic device may fail to recognize the gesture. Therefore, it is important to obtain a clearer gesture signal by removing the vibration signal from the signal detected by the sensor module 176.

As described above with reference to FIG. 1, the sensor module 176 may include different sensors. For example, the sensor module 176 may include a first sensor and a second sensor. Different sensors included in the sensor module 176 may detect vibration signals in different physical forms. For example, the first sensor and the second sensor may detect vibration signals of different vibration axes. For example, when the first sensor is an acceleration sensor, the first sensor may detect vibration relative to a linear acceleration axis. For example, the first sensor may detect vibration that cause linear acceleration changes of the electronic device relative to three axes (e.g., an x-axis, a y-axis, and a z-axis) of the acceleration sensor. For example, when the second sensor is an angular velocity sensor, the second sensor may detect vibration relative to a rotation axis. For example, the second sensor may detect vibration that cause rotational changes of the electronic device relative to three axes (e.g., pitch, roll, and yaw) of the angular velocity sensor.

The vibration signal may be generated only in one specific sensor by the characteristics of the actuators 410 and 420 (e.g., actuator 410 generates a linear vibration and actuator 420 generates a circular vibration). When a frequency of the vibration is higher than a sensing frequency of the sensor, the vibration signal may lose periodicity and appear to be spread across the entire frequency band. In other words, there may not be a frequency that may distinguish a vibration signal from the signal obtained through the sensor module 176. A vibration signal may also overlap in the frequency band of the gesture signal in the signal obtained through the sensor module 176.

For example, the actuator 410 may generate a physically linear high frequency band (e.g., 180 Hz) vibration signal, and the actuator 420 may generate a physically circular low frequency band (e.g., 110 Hz) vibration signal. The frequency band of the vibration signal detectable by the first sensor and the second sensor may be close to 100 Hz. The vibration frequency (e.g., 180 Hz) of the vibration signal generated by the actuator 410 may be higher than the vibration frequency (e.g., 100 Hz) that may be detected by the first sensor and the second sensor. The vibration frequency (e.g., 110 Hz) of the vibration signal generated by the actuator 420 may be close to the vibration frequency (e.g., 100 Hz) that may be detected by the first sensor and the second sensor. Therefore, even if the vibration signal generated by the actuator 410 is detected by the first sensor, it may not be distinguished from the gesture signal in the frequency domain. However, the vibration frequency of the vibration signal generated by the actuator 420 may be close to the vibration frequency detectable by the second sensor. Therefore, when the electronic device analyzes (or monitors) the signal sensed through the second sensor in the frequency domain, the vibration signal generated by the actuator 420 may be distinguished from the gesture signal.

For better understanding, the results of the vibration signal generated from the actuator 410 being detected by the sensor module 176 may be shown as a graph 430. The graph 430 shows a graph in which a vibration signal is sensed by a first sensor (e.g., an acceleration sensor) of an electronic device, and a vibration signal is not sensed by a second sensor (e.g., an angular velocity sensor). For example, in a section 415 of the graph 430, a linear acceleration value is a predetermined threshold value or more, however, an angular velocity value is less than a specific threshold value. That is, in the section 415 of the graph 430, it may be confirmed that the vibration signal is detected by the acceleration sensor, but the vibration signal is not detected by the angular velocity sensor. Therefore, the graph 430 shows a case where the first sensor detects the vibration signal and the second sensor does not detect the vibration signal. In the first case 401, the electronic device may remove the vibration signal from the signal detected by the first sensor based on monitoring the signal detected by the first sensor in a time domain, thereby improving accuracy of gesture recognition of the user.

In another example, the result of the vibration signal generated from the actuator 420 being detected by the sensor module 176 may be shown as a graph 440. The graph 440 shows a graph in which a vibration signal is not sensed by a first sensor (e.g., an acceleration sensor) of an electronic device, and a vibration signal is sensed by a second sensor (e.g., an angular velocity sensor). For example, in a section 425 of the graph 440, it may be confirmed that a linear acceleration value is less than a predetermined threshold value, however, an angular velocity value is a specific threshold value or more. Therefore, the graph 440 may show a case where the second sensor detects the vibration signal and the first sensor does not detect the vibration signal. In the second case 402, the electronic device may remove the vibration signal from the signal detected by the second sensor based on monitoring the signal detected by the second sensor in a frequency domain, thereby improving accuracy of gesture recognition of the user.

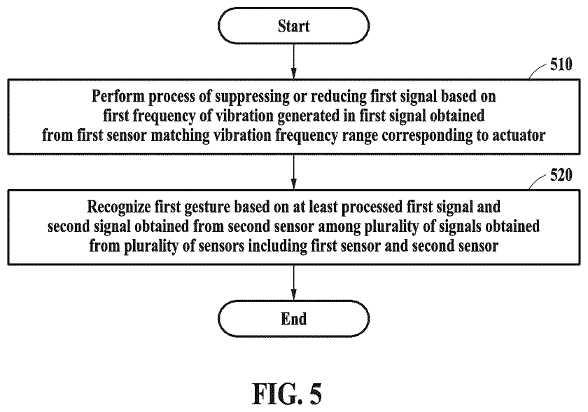

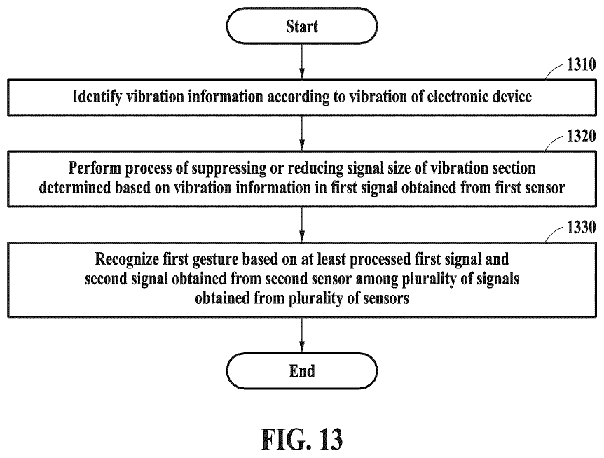

Hereinafter, a technology for recognizing a gesture of a user of an electronic device by reducing or removing a vibration signal among sensor signals measured on a time axis, even if the electronic device does not calculate a vibration section from the sensor signals will be described in greater detail with reference to FIGS. 5 to 12. A technology for recognizing a gesture of a user of an electronic device by calculating a vibration section from sensor signals measured on a time axis and reducing or removing a vibration signal from the vibration section by the electronic device will be described in greater detail with reference to FIGS. 13 to 23.

FIG. 5 is a flowchart illustrating an example method of processing a vibration signal by monitoring a signal obtained through a sensor in a frequency domain by an electronic device according to various embodiments.

In operation 510, an electronic device (e.g., the electronic device 101 of FIG. 1, the electronic device 200 of FIG. 2A, or the electronic device 300 of FIG. 3) may suppress or reduce a first signal based on a first frequency of vibration generated in a first signal obtained from a first sensor matching a vibration frequency range corresponding to an actuator.

The electronic device according to an embodiment may detect vibration information for vibration already generated or vibration to be generated in the electronic device. The vibration information is information representing vibration generated and/or sensed by the electronic device, and for example, the vibration information may include at least one of a vibration intensity, a vibration pattern, a vibration period, a vibration length, and a vibration time. The vibration pattern may represent vibration with a certain intensity repeated at predetermined intervals. The vibration may be generated by an actuator of the electronic device. As described with reference to FIG. 4, for example, when the electronic device identifies a gesture of a user, the actuator may provide vibration feedback in response to the identification of the gesture. In another example, the actuator may generate vibration in response to an alarm for an event occurring in the electronic device (e.g., receiving an incoming call or receiving a text message). A vibration frequency of a vibration signal generated by the actuator may be predetermined (e.g., specified) according to the type of actuator. For example, according to the type of a vibrator and the type of a vibration motor included in the actuator, the vibrator frequency of the actuator may be predetermined as 110 Hz or 180 Hz.

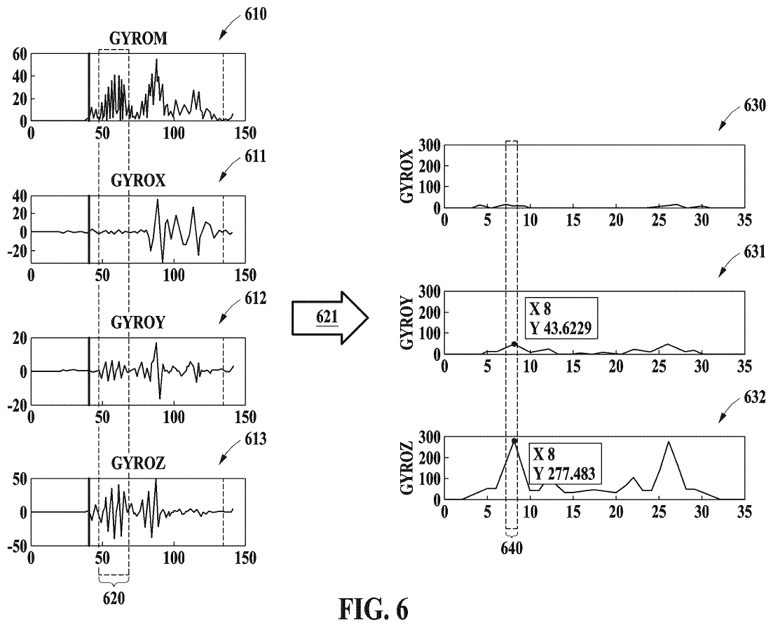

As described with reference to FIG. 4, the electronic device may distinguish between a gesture signal and a vibration signal by converting the first signal obtained from the first sensor into a frequency band. The electronic device may detect a first frequency, at which vibration is generated (e.g., a frequency component is largest), based on monitoring the first signal obtained from the first sensor in the frequency domain. The electronic device may suppress a vibration signal in the first signal by suppressing or reducing frequency components in a first frequency domain when the detected first frequency matches the vibration frequency of the actuator. In other words, the electronic device may suppress or reduce the vibration signal even if the vibration section of the first signal is not calculated in the time domain. A specific method of removing the vibration signal by monitoring the first signal in the frequency domain by the electronic device will be described below with reference to FIG. 6.

In operation 520, the electronic device according to an embodiment may recognize a first gesture based on at least the processed first signal and a second signal obtained from a second sensor among a plurality of signals obtained from a plurality of sensors. In other words, the electronic device may remove the vibration signal from the first signal and recognize the gesture of the user more accurately with the second signal.

FIG. 6 is a diagram including various graphs illustrating an example method of suppressing a vibration signal by monitoring a gesture signal of a user and the vibration signal in a frequency domain by an electronic device according to various embodiments.

An electronic device according to an embodiment (e.g., the electronic device 101 of FIG. 1, the electronic device 200 of FIG. 2A, or the electronic device 300 of FIG. 3) may perform conversion operation 621 of converting a signal obtained through a first sensor and/or a second sensor into a signal in a frequency domain. FIG. 6 illustrates an example in which the first sensor is a three-axis angular velocity sensor and the second sensor is a three-axis acceleration sensor. An example, in which an actuator included in the electronic device generates a vibration signal based on a characteristic of the actuator (e.g., the generated vibration signal is physically linear or circular), and the vibration signal may be detected only by the first sensor included in the electronic device, will be described. The first signal obtained through the first sensor may include periodicity of the vibration signal in the frequency domain. The periodicity of the vibration signal may indicate that the vibration signal is not spread evenly across the entire frequency domain, but is observed in a specific frequency range. Generally, the vibration frequency may be higher than a frequency of the gesture signal of the user. In other words, the electronic device may monitor the vibration signal in the frequency domain based on a predetermined frequency value that may distinguish the vibration signal regardless of the presence or absence of the gesture signal of the user. Accordingly, the electronic device may perform the monitoring by performing conversion operation 621 of converting the first signal obtained from the first sensor into the signal in the frequency domain. The electronic device may suppress or reduce a portion corresponding to the vibration signal in the first signal based on monitoring a frequency conversion result of the first signal. However, the electronic device should first determine whether the vibration is generated in the electronic device.

For convenience of understanding, when the first sensor corresponds to the three-axis angular velocity sensor, the results of the first sensor detecting the gesture signal and the vibration signal may be shown as graphs 610, 611, 612, and 613. The graph 611 is a graph for a first-axis angular velocity signal corresponding to the result of a first-axis angular velocity sensor included in the first sensor detecting the gesture signal and the vibration signal. The graph 612 is a graph for a second-axis angular velocity signal corresponding to the result of a second-axis angular velocity sensor included in the first sensor detecting the gesture signal and the vibration signal. In addition, the graph 613 is a graph for a third-axis angular velocity signal corresponding to the result of a third-axis angular velocity sensor included in the first sensor detecting the gesture signal and the vibration signal. The graph 610 is a graph for the first signal corresponding to the combined results of the first-axis angular velocity signal, the second-axis angular velocity signal, and the third-axis angular velocity signal. The electronic device may determine that the vibration is generated in the electronic device based on a first-axis signal in a section 620 of the graph 611, a second-axis signal in the section 620 of the graph 612, and a third-axis signal in the section 620 of the graph 613. Hereinafter, a case where the electronic device determines that the vibration is generated in the electronic device will be described.

The electronic device according to an embodiment may first perform conversion operation 621 of converting the first signal detected on a time axis into the signal in the frequency domain in order to determine that the vibration is generated in the electronic device. For example, the electronic device may perform conversion operation 621 of converting the first signal into the frequency domain signal by performing a fast Fourier transform (FFT) on the first signal. For example, when the first sensor corresponds to the three-axis angular velocity sensor, the electronic device may perform conversion operation 621 of converting the first-axis angular velocity signal obtained from the first-axis angular velocity sensor among the three-axis angular velocity sensors into the signal in the frequency domain through the FFT. In other words, the electronic device may perform conversion operation 621 of converting the graph 611 corresponding to the first-axis angular velocity signal into a graph 630 in the frequency domain. Similarly, the electronic device may perform conversion operation 621 of converting the graph 612 into a graph 631 in the frequency domain, and perform conversion operation 621 of converting the graph 613 into a graph 632 in the frequency domain.

The electronic device may determine that the vibration is generated in the electronic device based on a frequency component of the first-axis angular velocity signal, a frequency component of the second-axis angular velocity signal, and a frequency component of the third-axis angular velocity signal in the frequency domain. For example, when a frequency component corresponding to a first frequency (e.g., a frequency 640) in the first-axis angular velocity signal in the frequency domain (e.g., the first-axis angular velocity signal in the frequency domain corresponding to the graph 630) is less than a predetermined threshold value, a frequency component corresponding to the first frequency (e.g., the frequency 640) in the second-axis angular velocity signal in the frequency domain (e.g., the second-axis angular velocity signal in the frequency domain corresponding to the graph 631) is greater than or equal to the predetermined threshold value, and a frequency component corresponding to the first frequency (e.g., the frequency 640) in the third-axis angular velocity signal in the frequency domain (e.g., the third-axis angular velocity signal corresponding to the graph 632) is greater than or equal to the predetermined threshold value, the electronic device may determine that the vibration for the electronic device is generated. When the electronic device determines that the vibration for the electronic device is generated, the electronic device may suppress or reduce the vibration signal in the first signal by suppressing or reducing the frequency component of the frequencies (e.g., the first frequency and the frequency 640) corresponding to the vibration signal. For example, the electronic device may suppress or reduce the vibration signal in the first signal based on filtering in frequency components of a frequency domain less than the frequencies (e.g., the first frequency and the frequency 640) corresponding to the vibration signal in the first signal, and filtering out frequency components of a frequency domain greater than or equal to the frequencies (e.g., the first frequency and the frequency 640).

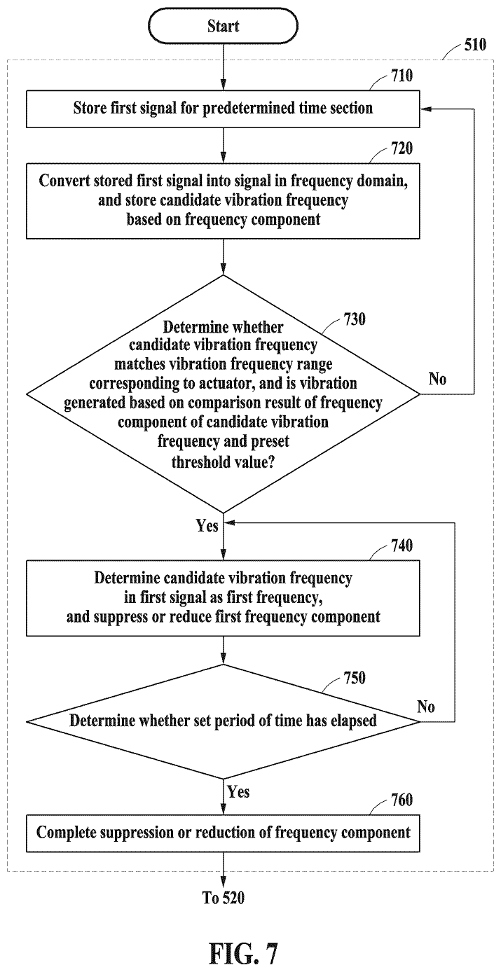

FIG. 7 is a flowchart illustrating an example method of suppressing a vibration signal by monitoring a gesture signal of a user and the vibration signal in a frequency domain by an electronic device according to various embodiments.

An electronic device according to an embodiment (e.g., the electronic device 101 of FIG. 1, the electronic device 200 of FIG. 2A, or the electronic device 300 of FIG. 3) may convert signals detected by a plurality of sensors including a first sensor and a second sensor for recognizing a gesture of a user, into a frequency domain. The electronic device may suppress or reduce the frequency component of a frequency, at which it is determined that the vibration is generated, based on monitoring the signals converted into the frequency domain. However, in the frequency domain, the gesture signal and the vibration signal may overlap in the same partial frequency domain. The electronic device may suppress or reduce the frequency component in a partial frequency domain, in which the gesture signal and the vibration signal overlap. As a result, the electronic device is likely to experience loss of information about the gesture signal in the partial frequency domain, in which the gesture signal and the vibration signal overlap. Therefore, the electronic device needs to accurately determine whether a specific frequency component in the frequency domain is a vibration signal not overlapping with the gesture signal. Hereinafter, a method of determining a frequency, at which it is determined that the vibration is generated, and a frequency component by monitoring the first signal obtained from the first sensor in the frequency domain, and suppressing or reducing the frequency component after it is determined that the vibration is generated, by the electronic device, will be described in detail. Hereinafter, operation 510 of FIG. 5 will be described in greater detail with reference to FIG. 7.

In operation 710, the electronic device may store a first signal obtained from a first sensor for a predetermined time section.

In an embodiment, the electronic device may include a three-axis angular velocity sensor as the first sensor. Although the type of the first sensor is not limited thereto, the following description focuses on a case where the first sensor is the three-axis angular velocity sensor. The three-axis angular velocity sensor may include a first-axis angular velocity sensor (e.g., an X-axis angular velocity sensor GYR X), a second-axis angular velocity sensor (e.g., a Y-axis angular velocity sensor GYR Y), and a third-axis angular velocity sensor (e.g., a Z-axis angular velocity sensor GYR Z). The first signal detected by the first sensor may represent a combined signal of a first-axis angular velocity signal detected through the first-axis angular velocity sensor, a second-axis angular velocity signal detected through the second-axis angular velocity sensor, and a third-axis angular velocity signal detected through the third-axis angular velocity sensor. Accordingly, the electronic device may store each of a first angular velocity signal, a second angular velocity signal, and a third angular velocity signal for a predetermined time section. The electronic device may store the first signal combining the first-axis to third-axis angular velocity signals. For example, when the predetermined time section is 320 ms and operation frequencies of the first angular velocity sensor, the second angular velocity sensor, and the third angular velocity sensor included in the first sensor are 100 Hz, the electronic device may sample and store 32 of each of the first angular velocity signal, the second angular velocity signal, and the third angular velocity signal.

In operation 720, the electronic device may convert the stored first signal into the signal in the frequency domain, and store a candidate vibration frequency based on the frequency component.

In an embodiment, the electronic device may perform the FFT of a predetermined size (e.g., an N-size FFT) on each of the stored first angular velocity signal, second angular velocity signal, and third angular velocity signal to extract Fourier coefficients. The Fourier coefficients may correspond to frequency components. For example, the electronic device may perform the 32-size FFT on each of the 32 sampled first angular velocity signals, the 32 sampled second angular velocity signals, and the 32 sampled third angular velocity signals, to extract Fourier coefficients corresponding to the frequency components. The electronic device may store a frequency corresponding to a maximum value among the extracted Fourier coefficients, e.g., the frequency components, as a candidate vibration frequency. For example, the electronic device may store a frequency corresponding to a maximum value among frequency components in the frequency domain of the first-axis angular velocity signal as a first-axis candidate vibration frequency. For example, the electronic device may store a frequency corresponding to a maximum value among frequency components in the frequency domain of the second-axis angular velocity signal as a second-axis candidate vibration frequency. For example, the electronic device may store a frequency corresponding to a maximum value among frequency components in the frequency domain of the third-axis angular velocity signal as a third-axis candidate vibration frequency.

In operation 730, the electronic device may determine whether the stored candidate vibration frequency matches a vibration frequency range corresponding to the actuator, and may determine that the vibration for the electronic device is generated based on a comparison result of a frequency component corresponding to the candidate vibration frequency and a predetermined threshold value.

In an embodiment, the electronic device may determine whether the candidate vibration frequency matches the vibration frequency range corresponding to the actuator. As described with reference to FIG. 4, the actuator may generate a vibration signal in a specific vibration frequency range according to hardware characteristics. The actuator may be controlled to generate a vibration signal in a vibration frequency range desired by a user based on an internal algorithm or a control signal. In other words, the range of vibration frequencies generated in the electronic device may be predetermined according to the type of actuator. For example, when N is 32, a fifth or sixth Fourier coefficient among Fourier coefficients corresponding to the 32-size FFT for the first signal may fall within the vibration frequency range corresponding to the actuator. When the first-axis candidate vibration frequency is more than a predetermined threshold value away from the vibration frequency range corresponding to the actuator, and the second-axis candidate vibration frequency and the third-axis candidate vibration frequency are closer to the vibration frequency range corresponding to the actuator by the predetermined threshold value or less, the electronic device may determine that the candidate vibration frequency matches the vibration frequency range corresponding to the actuator. Simultaneously (or substantially simultaneously), when a frequency component of the first-axis candidate vibration frequency is less than the predetermined threshold value, and a frequency component of the second-axis candidate vibration frequency and a frequency component of the third-axis candidate vibration frequency are greater than or equal to the predetermined threshold value, the electronic device may determine that the vibration for the electronic device is generated.

In operation 740, when it is determined that the vibration is generated, the electronic device may determine the candidate vibration frequency in the first signal as the first frequency, and suppress or reduce the vibration signal included in the first signal based on the first frequency.

In an embodiment, the electronic device may suppress or reduce the vibration signal included in the first signal for a preset period of time. For example, the electronic device may set a maximum vibration time of the vibration signal generated by the actuator to 4.8 seconds. When the electronic device sets the maximum vibration time of the vibration signal generated by the actuator to 4.8 seconds, the electronic device may suppress or reduce the vibration signal included in the first signal for 4.8 seconds. The electronic device may determine the candidate vibration frequency as the first frequency (e.g., the frequency 640 of FIG. 6) in the first signal. The electronic device may suppress or reduce the first signal by filtering in frequency components in a frequency domain less than the first frequency and filtering out frequency components in a frequency domain higher than or equal to the first frequency for the preset period of time.

In operation 750, the electronic device may determine whether the preset period of time has elapsed. For example, the electronic device may determine whether the preset period of time has elapsed at regular time intervals. For example, the electronic device may determine whether the preset period of time corresponding to the maximum vibration time has elapsed at one-second intervals.

In operation 760, when it is determined that the preset period of time has elapsed, the electronic device may determine that the suppression or the reduction of the frequency component is completed.

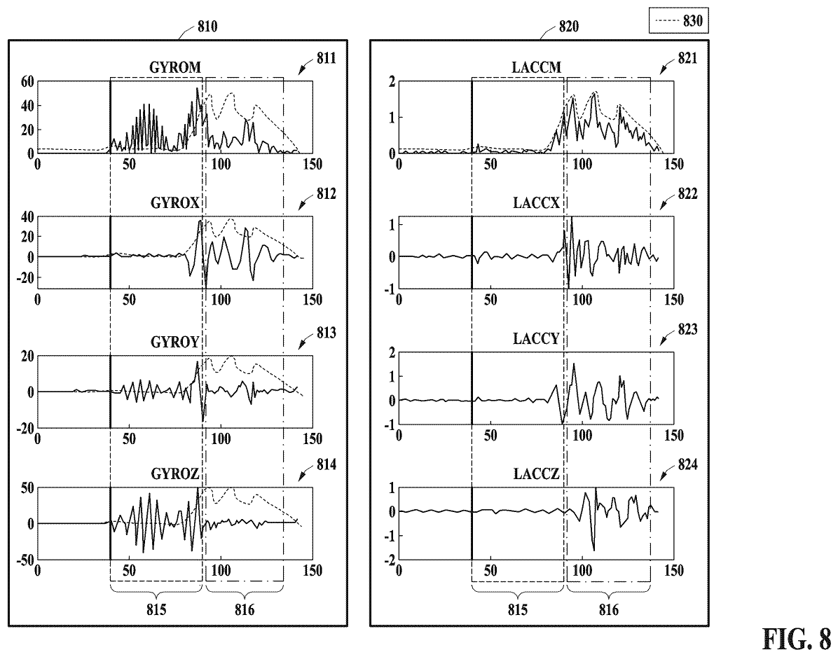

FIG. 8 is a diagram including graphs illustrating an example method of suppressing or reducing a vibration signal based on a pattern of a sensor signal that does not have influence of a vibration signal in a time domain by an electronic device according to various embodiments.

An electronic device according to an embodiment (e.g., the electronic device 101 of FIG. 1, the electronic device 200 of FIG. 2A, or the electronic device 300 of FIG. 3) may include a first sensor and a second sensor. For example, the electronic device may detect vibration feedback generated in the electronic device in response to a gesture of a user, or a vibration signal generated based on an event (e.g., a phone call, a text message, or the like) occurring in the electronic device using the first sensor and the second sensor. A vibration frequency range of the vibration detected by the first sensor may be different from physical properties of the vibration detected by the second sensor. For example, the vibration detected by the first sensor may correspond to vibration that occurs based on a rotational movement. In addition, the vibration detected by the second sensor may correspond to vibration that occurs based on a linear movement. In other words, based on the physical properties of a vibration signal generated in the electronic device, the first sensor may detect the vibration, and the second sensor may not detect the vibration. Hereinafter, a method of removing a vibration signal by monitoring a first signal along a time axis based on a second signal obtained from a second sensor that is not affected by vibration by an electronic device will be described in greater detail.

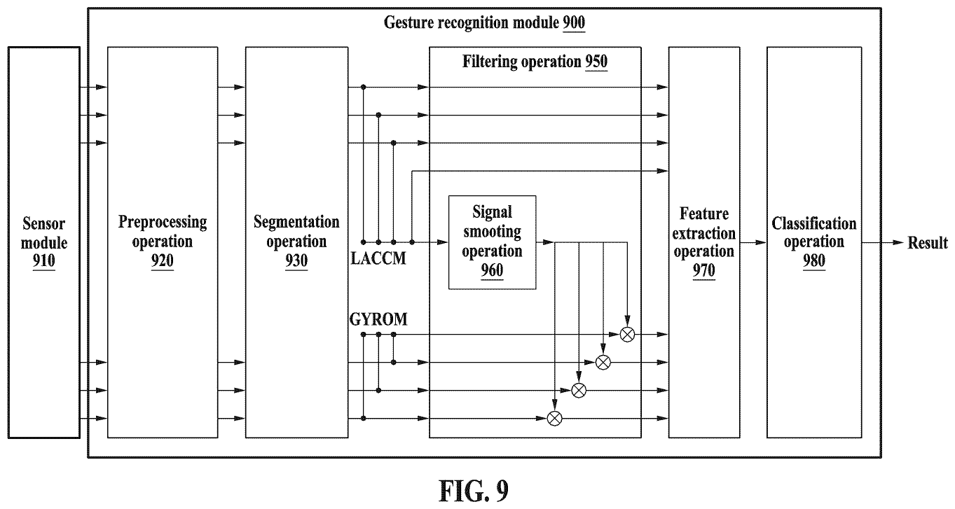

FIG. 8 illustrates graphs 811, 812, 813, and 814 for a first signal 810 obtained from the first sensor of the electronic device and graphs 821, 822, 823, and 824 for a second signal 820 obtained from the second sensor. The graphs 811, 812, 813, and 814 may include a vibration signal in a section 815, and include a gesture signal in a section 816. The graphs 821, 822, 823, and 824 may not include a vibration signal in the section 815, and may include a gesture signal in the section 816. In other words, the first signal 810 obtained from the first sensor may include the vibration signal and the gesture signal, and the second signal 820 obtained from the second sensor may include only the gesture signal. The electronic device may extract an envelope signal 830 based on the pattern of the second signal 820. For example, the electronic device may extract the envelope signal 830 from a signal included in at least one graph of the graphs 821, 822, 823, and 824 corresponding to the second signal 820 that does not include the vibration signal. When the second sensor corresponds to the three-axis acceleration sensor, the graph 821 (e.g., LACC M) may correspond to a graph that sums all of the graph 822 (e.g., LACC X) of a signal obtained by the first-axis acceleration sensor among the three-axis acceleration sensor, the graph 823 (e.g., LACC Y) of a signal obtained by the second-axis acceleration sensor, and the graph 824 (e.g., LACC Z) of a signal obtained by the third-axis acceleration sensor. Although FIG. 8 illustrates that the electronic device extracts the envelope signal 830 based on the signal included in the graph 821 of the second signal 820, the electronic device may also extract an envelope signal from the graph 822, the graph 823, or the graph 824. The extracted envelope signal 830 may exhibit characteristics such that it does not include the vibration signal in the section 815 but includes the gesture signal of the user in the section 816. For reference, the envelope signal 830 may refer to a signal representing a change in the size of a complex vibration signal. The envelope signal 830 may include information on an amplitude of a signal that changes over time. For example, the electronic device may extract the envelope signal 830 from the second signal 820 based on a Hilbert transform or an upper and lower envelope extraction method. However, the above examples are merely an example of the method of extracting the envelope signal 830 by the electronic device, and the method of extracting the envelope signal 830 by the electronic device is not limited thereto. The electronic device may smooth the envelope signal 830. The electronic device may reduce a distortion of the second signal 820 that occurs when extracting the envelope signal 830 from the second signal 820 by smoothing the envelope signal 830. The method of smoothing the envelope signal 830 by the electronic device will be described in greater detail below with reference to FIGS. 9 to 11 below.

The electronic device may perform the process of suppressing or reducing the first signal 810 based on the extracted envelope signal 830. For example, the electronic device may suppress or reduce the first signal 810 by applying the extracted envelope signal 830 to the first signal 810 as a filter. For example, the electronic device may multiply the extracted envelope signal 830 by the first signal 810 to strengthen the signal in the section 816 including the gesture signal in the first signal, and weaken the signal in the section 815 including the vibration signal. For example, when the first sensor corresponds to the three-axis angular velocity sensor, the graph 811 (e.g., GYRO M) may correspond to a graph that sums all of the graph 812 (e.g., GYRO X) of a signal obtained from the first-axis angular velocity sensor, the graph 813 (e.g., GYRO Y) of a signal obtained from the second-axis angular velocity sensor, and the graph 813 (e.g., GYRO Z) of a signal obtained from the third-axis angular velocity sensor. The electronic device may suppress or reduce the vibration signal in the first signal 810 by multiplying the extracted envelope signal 830 by at least one of the signals shown in the graphs 811, 812, 813, and 814. The envelope signal 830 may have a value corresponding to “0” in the section 815. Accordingly, the electronic device may suppress or reduce the signal in the section 815 corresponding to the vibration signal by multiplying the envelope signal 830 by the signal shown in the graphs 811, 812, 813, and 814.

FIGS. 9,10 and 11 are diagrams illustrating an example configuration of a gesture recognition module included in an electronic device that suppresses or reduces a vibration signal based on an envelope signal according to various embodiments.

In an embodiment, an electronic device (e.g., the electronic device 101 of FIG. 1, the electronic device 200 of FIG. 2A, or the electronic device 300 of FIG. 3) may recognize a gesture of a user through a gesture recognition module 900. The electronic device may include a sensor module (e.g., including at least one sensor) 910 and the gesture recognition module (e.g., including various circuitry and/or executable program instructions) 900.

The sensor module 910 may transmit sensor signals generated by a plurality of sensors included in the sensor module 910 to the gesture recognition module 900. For example, an angular velocity signal may be generated from a gyro sensor, and a linear acceleration signal may be generated from a linear acceleration sensor.

The gesture recognition module 900 may receive a sensor signal from the sensor module 910 (e.g., the sensor module 176 of FIG. 1). For example, the sensor module 910 may include a first sensor (e.g., an angular velocity sensor GYRO) and a second sensor (e.g., an acceleration sensor LACC). Accordingly, the gesture recognition module 900 may receive a first signal from the first sensor included in the sensor module 910, and receive a second signal from the second sensor. At this time, the first signal may be a signal including a signal corresponding to the gesture of the user and vibration generated in the electronic device, and the second signal may be a signal including a signal corresponding to the gesture of the user. In other words, the first signal may refer to a signal including a vibration signal, and the second signal may refer to a signal not including a vibration signal. The gesture recognition module 900 may process a vibration signal included in the received sensor signal. For example, the gesture recognition module 900 may process the vibration signal included in the received sensor signal by performing preprocessing operation 920, segmentation operation 930, and filtering operation 950. The gesture recognition module 900 may recognize the gesture of the user of the electronic device by performing feature extraction operation 970 and classification operation 980 on the sensor signal with the processed vibration signal.

For example, as illustrated in FIG. 9, the gesture recognition module 900 of the electronic device may perform preprocessing operation 920. For example, in the preprocessing operation 920, the gesture recognition module 900 may remove a signal corresponding to the movement of the user other than the gesture of the user through a high-pass filter.

The gesture recognition module 900 may perform segmentation operation 930 to crop a portion where the signal jumps while monitoring the preprocessed sensor signal. For example, in segmentation operation 930, the gesture recognition module 900 may obtain a valid signal section by cropping a valid signal section within the preprocessed sensor signal. For example, the valid signal section may represent a section of the sensor signal including a sensor signal greater than or equal to a predetermined threshold value. For example, if the user of the electronic device leaves the electronic device alone, the sensor signal may indicate 0. When the user moves the electronic device, the sensor signal of the electronic device may have a value other than 0 according to the movement by the user. At this time, the section including the signal generated according to the movement of the electronic device may be named as a valid signal section.

The gesture recognition module 900 may perform filtering operation 950 of suppressing or reducing a vibration signal in the sensor signal cropped through segmentation operation 930. For example, in FIG. 9, it is assumed that the first signal (e.g., GYRO M) received by the gesture recognition module 900 from the first sensor included in the sensor module 910 includes a vibration signal. In FIG. 9, it is assumed that the second signal (e.g., LACC M) received by the gesture recognition module 900 from the second sensor included in the sensor module 910 does not include a vibration signal. The gesture recognition module 900 may extract an envelope signal (e.g., the envelope signal 830 of FIG. 8) corresponding to the second signal (e.g., LACC M) that does not include a vibration signal. The gesture recognition module 900 may perform smoothing operation 960 on the extracted envelope signal. For example, the gesture recognition module 900 may perform a 5-tap smoothing operation on the amplitude of the envelope signal. For reference, the 5-tap smoothing operation may represent an operation of smoothing an envelope signal by calculating an average using five pieces of data included in the envelope signal. In another example, the gesture recognition module 900 may perform smoothing operation 960 of performing simplification using a rectangular function based on the amplitude of the envelope signal. In other words, the gesture recognition module 900 may select specific smoothing operation 960 from among the above examples based on the distortion of the signal. For example, the gesture recognition module 900 may amplify the gesture signal and simultaneously remove the vibration signal even if there is a distortion in the gesture signal, by smoothing the envelope signal with a rectangular function. In another example, the gesture recognition module 900 may remove only the vibration signal without a distortion of the gesture signal by smoothing the envelope signal based on the 5-tap smoothing operation. For the 5-tap smoothing operation, the amount of computation may be greater than the smoothing using the rectangular function. Therefore, the gesture recognition module 900 may reduce power consumption by selecting appropriate smoothing operation 960.

The gesture recognition module 900 may perform filtering operation 950 by multiplying a signal obtained by smoothing the envelope signal of the second signal by the first signal. Through this, the gesture recognition module 900 may suppress or reduce the vibration signal included in the first signal and amplify the gesture signal included in the first signal.

The gesture recognition module 900 may perform feature extraction operation 970 of extracting various features from a signal, in which the vibration signal is suppressed or reduced, obtained by performing filtering operation 950.

The gesture recognition module 900 may perform classification operation 980 of classifying the gesture signal from the signal, in which the vibration signal is suppressed or reduced, using several features obtained through feature extraction operation 970. Classifying the gesture signal may refer to determining the type of gesture corresponding to the gesture signal. For example, the type of gesture determined by the gesture recognition module 900 of the electronic device may include gestures such as an open-clench-open (OCO) gesture, clenching and opening a first twice, pinching the thumb and index finger together, or pinching the thumb and index finger together twice.

For example, in classification operation 980, the gesture recognition module 900 may classify the gesture signal based on inputting several features of the signal extracted through feature extraction operation 970 into a classifier. For example, the classifier may include a machine learning model, a deep learning model, and a neural network model capable of classifying gestures. The classifier may be trained based on machine learning or deep learning and may classify gesture signals with high accuracy. For example, in FIG. 9, the gesture recognition module 900 may perform classification operation 980 based on a classifier trained with a signal obtained by performing filtering operation 950 through the envelope signal corresponding to the second signal (e.g., LACC M).

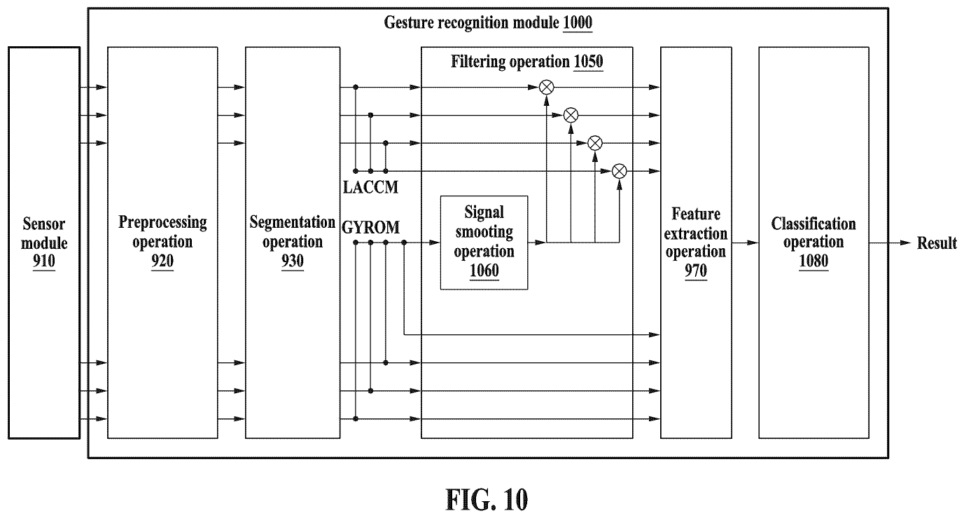

In FIG. 10, it is assumed that the first signal (e.g., GYRO M) received by a gesture recognition module 1000 of the electronic device from the sensor module 910 does not include a vibration signal, and the second signal (e.g., LACC M) includes a vibration signal. In FIG. 10, preprocessing operation 920, segmentation operation 930, and feature extraction operation 970 performed by the gesture recognition module 1000 are the same as the operations performed by the gesture recognition module 900 of FIG. 9, and therefore may not be described in detail again.

In FIG. 10, the gesture recognition module 1000 may extract an envelope signal from the first signal (e.g., GYRO M) that does not include a vibration signal. The gesture recognition module 1000 may perform smoothing operation 1060 on the extracted envelope signal. For example, the gesture recognition module 1000 may perform a 5-tap smoothing operation on the extracted envelope signal. The gesture recognition module 1000 may perform filtering operation 1050 by multiplying a signal obtained by smoothing the envelope signal of the first signal by the second signal. Through this, the gesture recognition module 1000 may suppress the vibration signal included in the second signal and amplify the gesture signal.

The gesture recognition module 1000 may perform classification operation 1080 in the same manner as classification operation 980 performed in FIG. 9. However, when the gesture recognition module 1000 performs classification operation 1080 through a classifier, the classifier for performing classification operation 1080 may be a classifier trained based on machine learning or deep learning using a signal obtained by performing filtering operation 1050 through the envelope signal corresponding to the first signal (e.g., GYRO M).

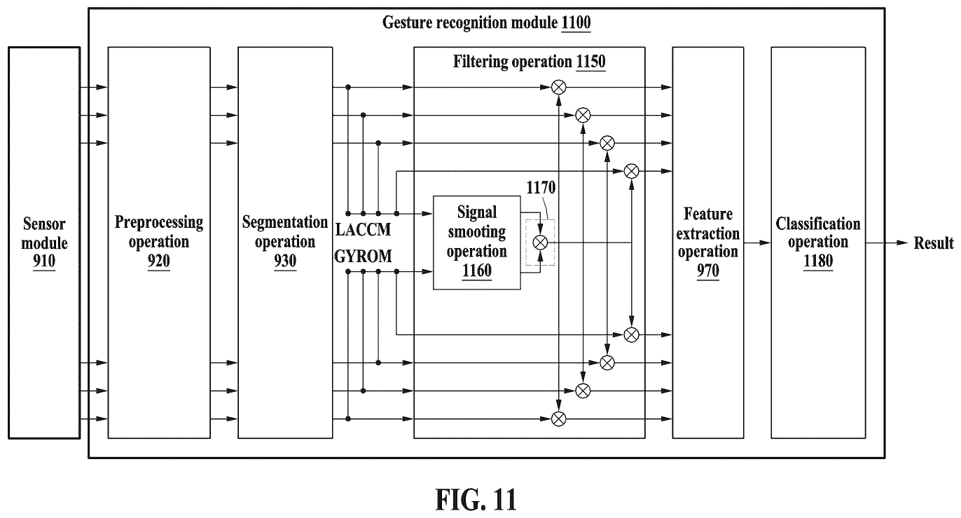

FIG. 11 is a diagram illustrating that a gesture recognition module 1100 extracts an envelope signal corresponding to the first signal (e.g., GYRO M) received from the sensor module 910, further extracts another envelope signal corresponding to the second signal (e.g., LACC M), and then performs filtering operation 1150 on a combined envelope signal generated by performing combining operation 1170 of combining the envelope signal and the other envelope signal.

In FIG. 11, preprocessing operation 920, segmentation operation 930, and feature extraction operation 970 performed by the gesture recognition module 1100 are the same as the operations performed by the gesture recognition module 900 in FIG. 9 and the gesture recognition module 1000 in FIG. 10, and therefore may not be described in detail again.

The gesture recognition module 1100 may extract an envelope signal corresponding to the first signal (e.g., GYRO M) in a valid signal section obtained through segmentation operation 930, and may extract another envelope signal corresponding to the second signal (e.g., LACC M) in the valid signal section. The gesture recognition module 1100 may perform smoothing operation 1160 on the envelope signal corresponding to the first signal and the other envelope signal corresponding to the second signal. The gesture recognition module 1100 may generate a combined envelope signal by performing combining operation 1170 of combining the envelope signal, on which smoothing operation 1160 is performed, and the other envelope signal, on which smoothing operation 1160 is performed. In other words, the gesture recognition module 1100 may extract envelope signals from all signals without having to check which of the first signal and the second signal received from the sensor module 910 includes a vibration signal, and generate the combined envelope signal by performing combining operation 1170 of combining the extracted envelope signals. For example, in a case where the envelope signal corresponding to the first signal has a value of 0 in a section corresponding to vibration, when the gesture recognition module 1100 performs combining operation 1170 (e.g., multiplication) of combining the envelope signal corresponding to the first signal and the other envelope signal corresponding to the second signal, the value of the section corresponding to the vibration in the combined envelope signal may correspond to 0. The gesture recognition module 1100 may suppress or reduce each of the first signal (e.g., GYRO M) and the second signal (e.g., LACC M) based on the combined envelope signal. For example, the gesture recognition module 1100 may suppress or reduce the vibration signal in the first signal (e.g., GYRO M) by multiplying the combined envelope signal by the first signal, and simultaneously suppress or reduce the vibration signal in the second signal (e.g., LACC M) by multiplying the combined envelope signal by the second signal.

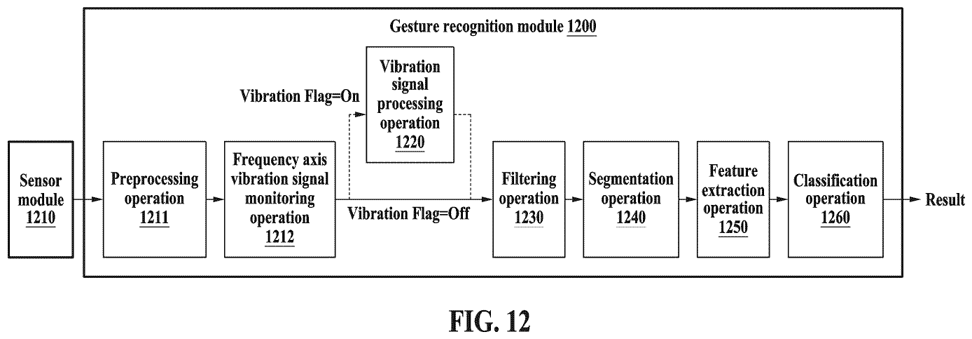

FIG. 12 is a diagram illustrating an example gesture recognition module of an electronic device performing a method of monitoring a vibration frequency and an example method of suppressing or reducing a vibration signal based on an envelope signal according to various embodiments.

An electronic device according to an embodiment (e.g., the electronic device 101 of FIG. 1, the electronic device 200 of FIG. 2A, or the electronic device 300 of FIG. 3) may recognize a gesture of a user through a gesture recognition module 1200. The electronic device may include a sensor module (e.g., including at least one sensor) 1210 and the gesture recognition module (e.g., including various circuitry and/or executable program instructions) 1200. The sensor module 1210 included in the electronic device is the same as the sensor module 910 described with reference to FIG. 9, and thus, a duplicate description may not be repeated here.

The gesture recognition module 1200 may suppress or reduce the vibration signal from a sensor signal received from the sensor module 1210 to recognize a gesture of the user. The gesture recognition module 1200 may perform at least one of frequency axis vibration monitoring operation 1212 and filtering operation 1230 based on an envelope signal in order to remove the vibration signal from the sensor signal. In FIG. 12, it is illustrated that the gesture recognition module 1200 performs frequency axis vibration monitoring operation 1212 before filtering operation 1230 through the envelope signal extracted based on time axis vibration monitoring, but the order of operations performed by the gesture recognition module 1200 is not limited thereto. For example, the gesture recognition module 1200 may first perform filtering operation 1230 based on the envelope signal, and then perform frequency axis vibration monitoring operation 1212. The gesture recognition module 1200 may perform segmentation operation 1230 before removing the vibration signal, or perform segmentation operation 1230 after removing the vibration signal. In other words, the order of operations 1210, 1211, 1212, 1220, 1230, 1240, 1250, and 1260 shown in FIG. 12 may be changed.

The gesture recognition module 1200 may perform preprocessing operation 1211, frequency axis vibration signal monitoring operation 1212, vibration signal processing operation 1220, filtering operation 1230, segmentation operation 1240, feature extraction operation 1250, and classification operation 1260 on a sensor signal received from the sensor module 1210. Preprocessing operation 1211, segmentation operation 1240, feature extraction operation 1250, and classification operation 1260 performed by the gesture recognition module 1200 are the same as the operations in FIGS. 9 to 11, thus a duplicate description may not be repeated here.

The gesture recognition module 1200 may perform frequency axis vibration signal monitoring operation 1212 and vibration signal processing operation 1220. For example, in frequency axis vibration signal monitoring operation 1212, the gesture recognition module 1200 may determine whether the vibration is generated by converting a sensor signal generated by preprocessing operation 1211 into a signal in a frequency domain. When it is determined that the vibration is generated in the sensor signal through frequency monitoring operation 1212, the gesture recognition module 1200 may perform vibration signal processing operation 1220 of suppressing or reducing a frequency component corresponding to a vibration frequency. However, since frequency monitoring operation 1212 is a method of removing a vibration signal from a sensor signal when vibration frequencies of a vibration signal and a gesture signal do not overlap each other, it may not be possible to completely remove the vibration signal included in the sensor signal only by frequency axis vibration signal monitoring operation 1212 and vibration signal processing operation 1220.

The gesture recognition module 1200 may perform filtering operation 1230 corresponding to one of filtering operations 950, 1050, and 1150 described with reference to FIGS. 9 to 11 on the sensor signal generated in frequency axis vibration signal monitoring operation 1212 or vibration signal processing operation 1220. For example, the gesture recognition module 1200 may perform filtering operation 1230 on a sensor signal, from which a vibration signal that is distinguished from a gesture signal in the frequency domain is removed by vibration signal processing operation 1220. In another example, when the vibration signal and the gesture signal are not distinguished in the frequency domain, the gesture recognition module 1200 may perform filtering operation 1240 on the sensor signal after frequency axis vibration signal monitoring operation 1212 without vibration signal processing operation 1220.

In other words, the gesture recognition module 1200 may secondarily remove the vibration signal by monitoring a vibration signal not removed in frequency axis vibration signal monitoring operation 1212 through filtering operation 1230 on a time axis.

The gesture recognition module 1200 may recognize a gesture of the user for the electronic device by performing segmentation operation 1240, feature extraction operation 1250, and classification operation 1260 on the sensor signal generated after filtering operation 1230.

The electronic device according to various embodiments may be one of various types of electronic devices. The electronic device may include, for example, a portable communication device (e.g., a smartphone), a computer device, a portable multimedia device, a portable medical device, a camera, a wearable device, a home appliance device, or the like. According to an embodiment of the disclosure, the electronic device is not limited to those described above.

It should be appreciated that various embodiments of the disclosure and the terms used therein are not intended to limit the technological features set forth herein to particular embodiments and include various changes, equivalents, or replacements for a corresponding embodiment. In connection with the description of the drawings, like reference numerals may be used for similar or related components. It is to be understood that a singular form of a noun corresponding to an item may include one or more of the things, unless the relevant context clearly indicates otherwise. As used herein, “A or B”, “at least one of A and B”, “at least one of A or B”, “A, B or C”, “at least one of A, B and C”, and “at least one of A, B, or C,” may include any one of the items listed together in the corresponding one of the phrases, or all possible combinations thereof. Terms such as “1^{st}”, “2^{nd}”, or “first” or “second” may simply be used to distinguish the component from other components in question, and do not limit the components in other aspects (e.g., importance or order). It is to be understood that if a component (e.g., a first component) is referred to, with or without the term “operatively” or “communicatively”, as “coupled with,” “coupled to,” “connected with,” or “connected to” another component (e.g., a second component), the component may be coupled with the other component directly (e.g., by wire), wirelessly, or via a third component.

As used in connection with various embodiments of the disclosure, the term “module” may include a unit implemented in hardware, software, or firmware, or any combination thereof, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., the internal memory 136 or the external memory 138) that is readable by a machine (e.g., the electronic device 101) For example, a processor (e.g., the processor 120) of the machine (e.g., the electronic device 101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the “non-transitory” storage medium is a tangible device, may does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read-only memory (CD-ROM)), or be distributed (e.g., downloaded or uploaded) online via an application store (e.g., PlayStore™), or between two user devices (e.g., smartphones) directly. If distributed online, at least portion of the computer program product may be temporarily generated or at least temporarily stored in the machine-readable storage medium, such as memory of the manufacturer's server, a server of the application store, or a relay server.

According to embodiments, each component (e.g., a module or a program) of the above-described components may include a single entity or multiple entities, and some of the multiple entities may be separately disposed in different components. According to embodiments, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

A technology for recognizing a gesture of a user of an electronic device by reducing or removing a vibration signal among sensor signals, even if the electronic device does not calculate a vibration section from a sensor signal measured on a time axis, has been described. Hereinafter, a technology for reducing or removing a vibration signal in a vibration section by calculating a vibration section from a sensor signal measured on a time axis by an electronic device will be described in greater detail.

FIG. 13 is a flowchart illustrating an example method of processing a vibration signal included in a vibration section by an electronic device according to various embodiments.

In operation 1310, an electronic device (e.g., the electronic device 101 of FIG. 1, the electronic device 200 of FIG. 2A, or the electronic device 300 of FIG. 3) may identify vibration information according to vibration.

In operation 1320, the electronic device may perform a process of suppressing or reducing a signal size of a vibration section determined based on the vibration information in a first signal obtained from a first sensor.

In an embodiment, the electronic device may include a plurality of sensors including the first sensor and a second sensor for recognizing a gesture of the user. The first sensor may represent a sensor that may detect vibration. The first sensor may include a linear acceleration sensor. The second sensor may represent a sensor other than the first sensor. The second sensor may be a sensor that detects vibration of physical properties different from the first sensor. For example, the vibration detected by the first sensor may be linear vibration. In another example, the vibration detected by the second sensor may be circular vibration. For example, the second sensor may include at least one of a gyro sensor, a PPG sensor, or an EMG sensor different from the first sensor. In FIG. 13 and below, the description is based on a case where the first sensor is a linear acceleration sensor and the second sensor is a gyro sensor, but is not limited thereto. In the disclosure, the first sensor or the second sensor is an example way to express distinct sensors and is not for limitation.

In operation 1330, the electronic device may recognize the first gesture based on at least a processed first signal and a second signal obtained from the second sensor among a plurality of signals obtained from a plurality of sensors.

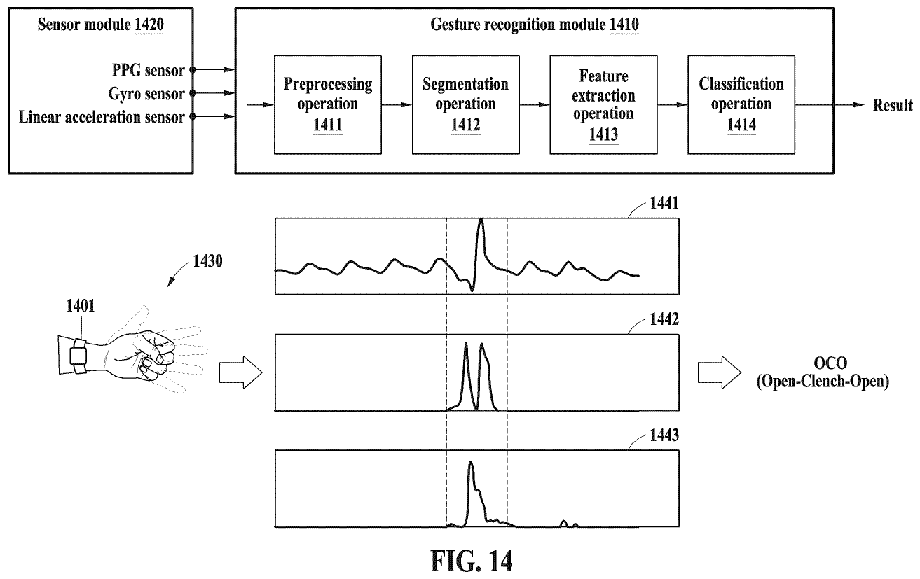

FIG. 14 is a diagram including graphs illustrating an example process of recognizing a gesture of a user by an electronic device according to various embodiments.

Gesture recognition is used in a variety of applications. For example, when a phone call comes in, a user wearing an electronic device 1401 (e.g., the electronic device 101 of FIG. 1, the electronic device 200 of FIG. 2A, or the electronic device 300 of FIG. 3) may perform an OCO gesture 1430 to receive the call, and the electronic device 1401 may perform a function of receiving the incoming call in response to the recognition of the OCO gesture 1430 of the user. The electronic device 1401 may recognize the gesture of the user through a gesture recognition module 1410. Hereinafter, the process of generally recognizing a gesture of the user by the electronic device 1401 will be described in greater detail.

The gesture recognition module 1410 may communicate with a sensor module 1420 including a plurality of sensors including a first sensor and a second sensor. The first sensor may include a linear acceleration sensor. The second sensor may be a sensor other than a linear acceleration sensor, for example, a gyro sensor and a PPG sensor. Hereinafter, the description is based on a case where the first sensor is a linear acceleration sensor and the second sensor is a gyro sensor, but is not limited thereto. For example, the first sensor may be a gyro sensor and the second sensor may be a linear acceleration sensor. The gesture recognition module 1410 may be in the form of software stored in a memory (e.g., the memory 130 of FIG. 1) and executed by or included in an application (e.g., the application 146 of FIG. 1), or may be in the form of separate hardware.

The sensor module 1420 may transmit sensor signals generated by a plurality of sensors included in the sensor module 1420 to the gesture recognition module 1410. For example, an angular velocity signal may be generated from a gyro sensor, and a linear acceleration signal may be generated from a linear acceleration sensor.

The gesture recognition module 1410 may determine a gesture performed by the user based on sensor signals (e.g., a PPG signal 1441, an angular velocity signal 1442, and/or a linear acceleration signal 1443) received from the sensor module 1420. The gesture recognition module 1410 may synchronize a sampling period of the sensors included in the sensor module 1420.

The gesture recognition module 1410 may perform preprocessing operation 1411 on the sensor signal. For example, in preprocessing operation 1411, the gesture recognition module 1410 may perform a function of removing a signal corresponding to a movement of the user other than the gesture of the user through a high-pass filter.

The gesture recognition module 1410 may then perform segmentation operation 1412 of cropping a portion, where the signal jumps, while observing the preprocessed sensor signal. For example, in segmentation operation 1412, the gesture recognition module 1410 may obtain a valid signal section by cropping a valid signal section within the preprocessed sensor signal.

The gesture recognition module 1410 may perform feature extraction operation 1413 of extracting several features from a signal section obtained by performing segmentation operation 1412.

The gesture recognition module 1410 may perform classification operation 1414 of classifying a gesture signal appearing in a valid signal section using features of the valid signal section obtained through feature extraction operation 1413. Classifying the gesture signal may refer to determining the type of gesture corresponding to the gesture signal. The type of gesture determined by the electronic device 1401 may include, for example, gestures such as an OCO gesture, clenching and opening a first twice, pinching the thumb and index finger together, or pinching the thumb and index finger together twice.

For example, in classification operation 1414, the gesture recognition module 1410 may classify a gesture signal appearing in a valid signal section based on inputting features of the valid signal section into a classifier. For example, a classifier may include a network capable of classifying gestures. The network may have a boosting tree-based random forest structure. The network may be trained based on machine learning or deep learning and may classify gesture signals with high accuracy.

When a user wearing the electronic device 1401 performs a gesture, the muscles from the back of the hand to the elbow contract and relax slightly due to the movement of the fingers, and the electronic device 1401 shakes. Since the electronic device 1401 detects minute signals from the user's muscles through a sensor, patterns of sensor signals (e.g., the PPG signal 1441, the angular velocity signal 1442, and/or the linear acceleration signal 1443) may vary depending on the user or the state in which the electronic device 1401 is worn. Since many signal patterns may appear for each gesture, it is very difficult to classify gesture signals using rules created by humans. Therefore, it is necessary to mechanically learn gesture-specific features to generate numerous rules, and accurately classify gesture signals based on the generated rules. A network with a boosting tree-based random forest structure included in the classifier may generate accurate determination criteria for classifying gesture signals by comparing all the features of various signal patterns, and generate many determination criteria while increasing a classification accuracy of the gesture signals using the generated determination criteria, thereby avoiding being biased toward only one determination criterion. In other words, the network may avoid overfitting to specific signal patterns.

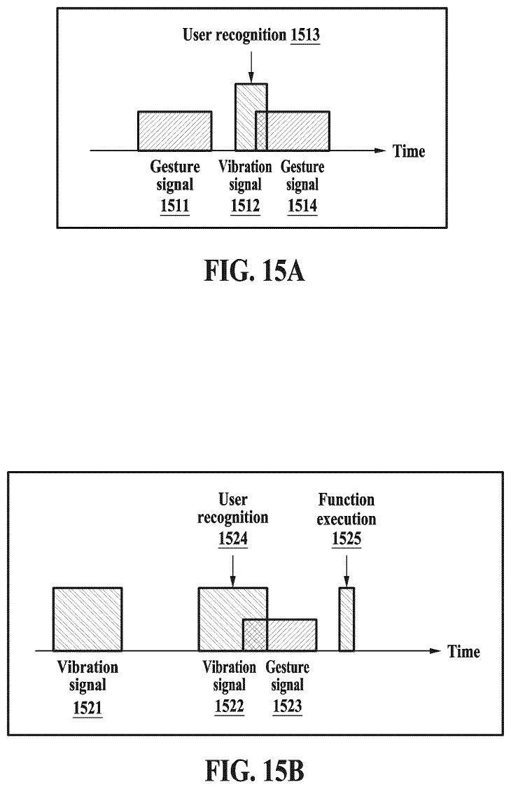

FIGS. 15A and 15B are diagrams illustrating an example scenario in which a gesture signal and a vibration signal overlap in a sensor signal detected in an electronic device according to various embodiments.

According to an embodiment, in a sensor (e.g., a first sensor or a second sensor) of an electronic device according to an embodiment (e.g., the electronic device 101 of FIG. 1, the electronic device 200 of FIG. 2A, the electronic device 300 of FIG. 3, or the electronic device 1401 of FIG. 14), a signal (hereinafter, a “gesture signal”) detected by performance of a gesture of the user and a signal (hereinafter, a “vibration signal”) detected by vibration generation in the electronic device may overlap each other. For example, the electronic device may generate vibration according to vibration feedback corresponding to a gesture, or generate vibration according to an alarm for an event occurring on the electronic device. The electronic device may detect the gesture signal within a section in which the vibration signal appears. In such cases, there may be a problem in which the vibration signal and the gesture signal overlap in a specific section and thus the gesture signal may not be accurately extracted.

FIG. 15A illustrates an example scenario in which a vibration signal detected by vibration according to vibration feedback and a gesture signal detected by performance of a gesture of a user overlap.

Vibration feedback may indicate vibration for notifying the user whether a user input is received properly when the electronic device receives the user input. When the electronic device receives the user input, the electronic device may generate the vibration feedback after a preset time from a time point at which the user input is received. The user input may include various inputs, for example, an input based on performance of a gesture of a user, a touch input of a user on a touch screen interface, and the like. A scenario in which the vibration feedback may affect the performance of gesture recognition will be described with reference to FIG. 15A.

Referring to FIG. 15A, the user of the electronic device may perform a gesture to control the electronic device. A sensor of the electronic device may detect a gesture signal 1511 generated by the performance of a gesture of the user. The electronic device may recognize the gesture performed by the user, and generate vibration as vibration feedback for notifying the user that the gesture is recognized properly and a function corresponding to the recognized gesture is executed, while executing the function corresponding to the recognized gesture. The sensor of the electronic device may detect a vibration signal 1512 by the vibration generated according to the vibration feedback. The user of the electronic device may recognize 1513 the vibration generated by the electronic device. The user who recognizes the vibration may recognize that a desired function has been executed, and perform a next gesture for a next control of the electronic device. It is common for the user to perform the next gesture after the vibration signal 1512 ends, however, as in FIG. 15A, the user who wants a quick control may perform the next gesture while the vibration signal 1512 is detected. In this case, a portion of a section in which the vibration signal 1512 is detected and a portion of a section in which a gesture signal 1514 according to the performance of the next gesture of the user is detected may overlap. Furthermore, the user may perform the next gesture in advance before the vibration signal 1512 is detected. Even in this case, a portion of the section in which the vibration signal 1512 is detected and a portion of the section in which the gesture signal 1514 generated according to the performance of the next gesture of the user is detected may overlap. In this case, there is a problem that, when classifying the gesture signal 1514 according to the next gesture, the gesture signal 1514 and the vibration signal 1512 may overlap, causing a pattern and features of the gesture signal 1514 to be distorted and thus resulting in an incorrect recognition result for the next gesture.

FIG. 15B illustrates an example scenario in which a vibration signal detected by vibration according to an alarm and a gesture signal detected by performance of a gesture of a user may overlap.

An alarm may indicate vibration that is generated at regular intervals. An event that triggers an alarm may include, for example, an incoming call, a message, or an application alarm from an external device. A scenario in which the alarm may affect the performance of gesture recognition will be described with reference to FIG. 15B.

Referring to FIG. 15B, the electronic device may detect an event corresponding to a vibration alarm (e.g., a call from an external device), and generate an alarm in response to the event detection. For example, the sensor of the electronic device may detect vibration signals 1521 and 1522 caused by the vibration generated according to the alarm. The user of the electronic device may recognize 1524 the vibration generated by the electronic device. The user who recognizes the vibration may recognize that the alarm is generated, and perform a gesture for a control of the electronic device. The sensor of the electronic device may detect a gesture signal 1523 generated by the performance of the gesture of the user. The electronic device may recognize the gesture performed by the user, and execute 1525 a function corresponding to the recognized gesture of the user. As illustrated in FIG. 15B, the user may perform the gesture while the vibration signal 1522 is detected. In this case, a portion of a section in which the vibration signal 1522 is detected and a portion of a section in which the gesture signal 1523 according to the performance of the gesture of the user is detected may overlap. In this case, there is a problem that the gesture signal 1523 and the vibration signal 1522 may overlap, causing a pattern and features of the gesture signal 1523 to be distorted and thus resulting in an incorrect recognition result for the gesture. The electronic device according to an embodiment may provide a technology for minimizing/reducing the effect of the vibration signal in a situation where the vibration signal and the gesture signal may overlap. The electronic device according to the disclosure provides a method of maintaining a high recognition rate for a gesture signal even when the gesture signal is affected by a vibration signal.

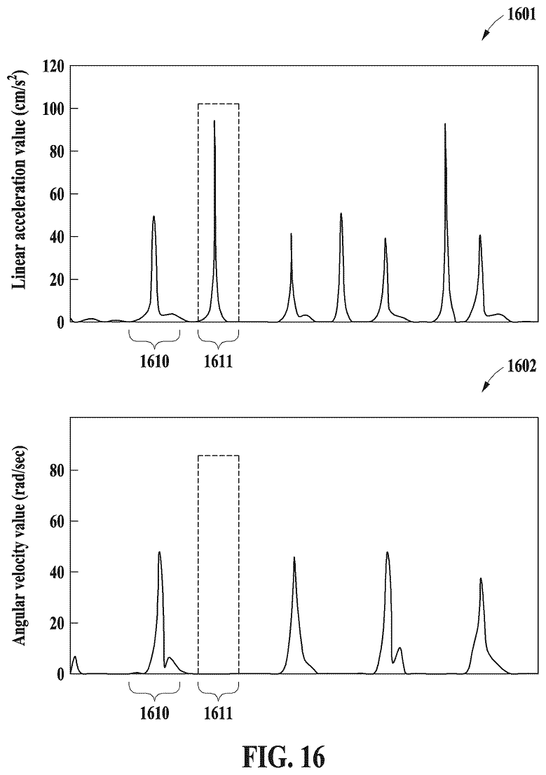

FIG. 16 is a diagram including graphs illustrating an example process of calculating a vibration section based on vibration information according to vibration by an electronic device according to various embodiments.

In an embodiment, an electronic device (e.g., the electronic device 101 of FIG. 1, the electronic device 200 of FIG. 2A, the electronic device 300 of FIG. 3, or the electronic device 1401 of FIG. 14) may identify vibration information based on vibration. The electronic device may suppress or reduce a signal size of a vibration section determined based on the vibration information in a first signal obtained from a first sensor. The electronic device may recognize a first gesture based on a processed first signal (e.g., a signal with a suppressed or reduced signal size in the vibration section) and a second signal obtained from a second sensor among a plurality of signals obtained from a plurality of sensors. Hereinafter, the vibration information according to vibration will be described in greater detail.

In an embodiment, the electronic device may generate vibration according to vibration feedback, or generate vibration according to an alarm for an event occurring in the electronic device.

In an embodiment, when the electronic device generates the vibration according to the vibration feedback, the vibration information identified by the electronic device may be information related to vibration corresponding to a second gesture that is recognized temporally earlier than the first gesture. When the electronic device generates the vibration according to the alarm for the event, the vibration information identified by the electronic device may be information related to the alarm for the event.

In an embodiment, the electronic device may include an actuator for generating vibration. The vibration information may be a control signal applied to the actuator. The electronic device may apply the control signal to the actuator to generate the vibration, and estimate the vibration section by confirming the applied control signal. For example, the control signal may include at least one of a vibration pattern, a vibration time, a vibration length, a vibration period, and a vibration magnitude.

In an embodiment, the vibration information may be information identified by a processor for the generation of vibration. For example, when the electronic device generates the vibration according to the vibration feedback, information on vibration to be generated in response to recognition of the second gesture may be loaded from a memory or an application. In another example, when the electronic device generates the vibration according to the alarm, information on vibration to be generated according to the alarm may be loaded from a memory or an application. For example, the information to be loaded may include at least one of a vibration pattern, a vibration time, a vibration length, a vibration period, and a vibration magnitude.

In an embodiment, the electronic device may calculate a vibration section based on the identified vibration information. For example, the electronic device may calculate the vibration section from at least one of a vibration pattern, a vibration period, a vibration period, a vibration length, and a vibration time included in the identified vibration information. Hereinafter, the operation of calculating the vibration section based on the identified vibration information by the electronic device will be described in more detail.

FIG. 16 illustrates sensor signals that appear when vibration in an electronic device and a gesture of a user occur at intervals from each other. A graph 1601 is a graph showing a first signal value (e.g., a linear acceleration value) for each time point measured by a first sensor (e.g., a linear acceleration sensor) of the electronic device. A graph 1602 is a graph showing a second signal value (e.g., an angular velocity value) for each time point measured by a second sensor (e.g., a gyro sensor) of the electronic device. A section 1610 is a section in which gesture signals caused by performance of a gesture of a user mainly appear. A section 1611 is a section in which vibration signals caused by vibration generated in the electronic device mainly appear.

In an embodiment, the electronic device may calculate a vibration section based on the first signal obtained (before processing) from the first sensor and the second signal obtained from the second sensor.

For example, the electronic device may calculate, as the vibration section, a period of time, in which the second signal is less than a second threshold value, within a time section in which the first signal exceeds a first threshold value. Referring to FIG. 16, when the vibration is generated in the electronic device, in the section 1611 in which the vibration signal mainly appears, the first signal value (e.g., the linear acceleration value) at an individual time point may appear to exceed the first threshold value, however, the second signal value (e.g., the angular velocity value) at the individual time point may appear to be less than the second threshold value. This is because a vibration frequency of the vibration detectable by the first sensor is different from a vibration frequency of the vibration detectable by the second sensor. For example, when the vibration is generated in the electronic device, a change in linear acceleration due to the vibration may be detected, however, a change in angular velocity may not be detected. For example, the first threshold value may be 60 cm/s², the second threshold value may be 10 rad/sec, and embodiments are not limited thereto.

In summary, in a case where the vibration in the electronic device and the gesture of the user occur at intervals, as in FIG. 16, the time section, in which the second signal is less than the second threshold value, within a section in which the first signal exceeds the first threshold value may be calculated as the vibration section. However, when the vibration in the electronic device and the gesture of the user occur adjacent to each other, the vibration signal and the gesture signal overlap at least partially, and a boundary between the vibration signal and the gesture signal becomes unclear. Accordingly, it is necessary to calculate the vibration section more precisely.

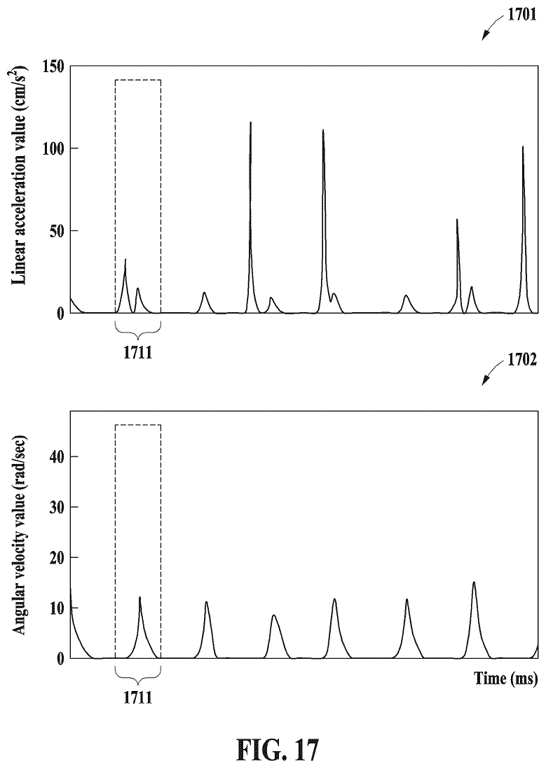

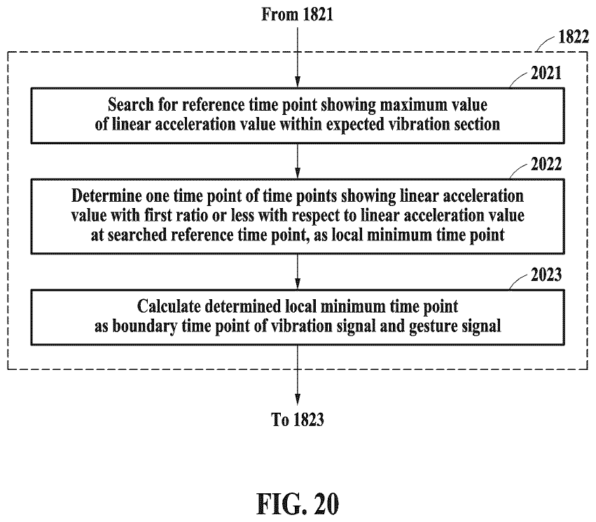

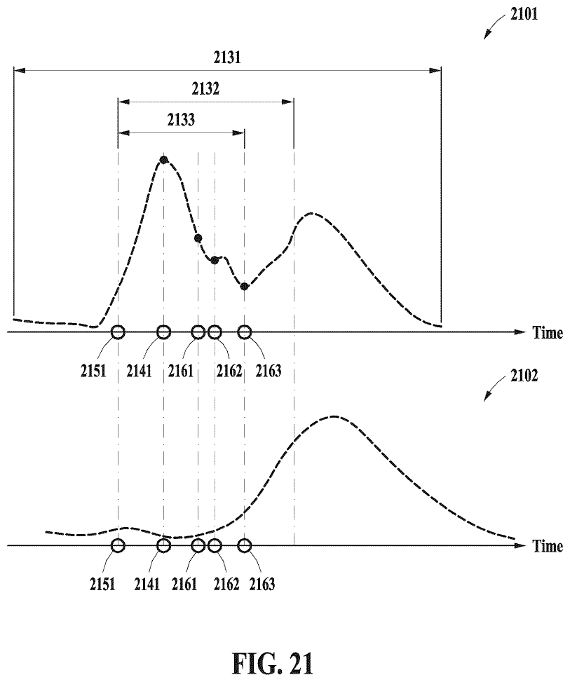

FIG. 17 is a diagram including graphs illustrating sensor signals that appear when vibration in an electronic device and a gesture of a user occur adjacent to each other according to various embodiments. A graph 1701 is a graph showing a first signal value (e.g., a linear acceleration value) for each time point measured by a first sensor (e.g., a linear acceleration sensor) of the electronic device. A graph 1702 is a graph showing a second signal value (e.g., an angular velocity value) for each time point measured by a second sensor (e.g., a gyro sensor) of the electronic device. A section 1711 is a section in which gesture signals caused by performance of a gesture of a user and vibration signals caused by vibration generation in the electronic device appear together. That is, in a section 1711, there may be a time point or a time section in which the gesture signal and the vibration signal overlap. The electronic device needs to detect the vibration section more precisely because a boundary between the vibration signal and the gesture signal is unclear within the section 1711. This is because the gesture signal may be distorted together when processing the vibration signal as many gesture signals are included in the vibration section. Hereinafter, a process of calculating a boundary time point between a vibration signal and a gesture signal when the vibration signal and the gesture signal overlap by an electronic device will be described in greater detail with reference to FIGS. 20 and 21.

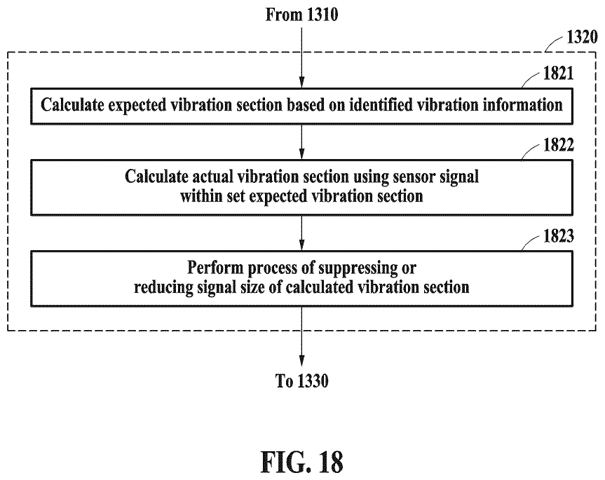

FIG. 18 is a flowchart illustrating an example process of setting an expected vibration section based on vibration information and calculating a vibration section within the expected vibration section by an electronic device according to various embodiments.

In an embodiment, an electronic device (e.g., the electronic device 101 of FIG. 1, the electronic device 200 of FIG. 2A, the electronic device 300 of FIG. 3, or the electronic device 1401 of FIG. 14) may calculate a vibration section within the entire time section, however, calculating the vibration section within the entire time section may be inefficient in terms of data processing. Therefore, the electronic device may first calculate the expected vibration section, in which the vibration is expected to be generated within the entire time section, and may calculate the vibration section within the calculated expected vibration section. In such a case, the electronic device may calculate the vibration section within the expected vibration section without calculating the vibration section within the entire time section, which may be efficient in terms of data processing. Hereinafter, a method of calculating the expected vibration section and calculating the vibration section from the expected vibration section will be described. The following operations may be operations that illustrate details of operation 1320 of FIG. 13.

In operation 1821, the electronic device may calculate an expected vibration section based on the identified vibration information.

In an embodiment, the electronic device may recognize the second gesture of the user and generate vibration according to the vibration feedback. In such a case, the electronic device may identify information related to the vibration corresponding to the recognized second gesture as the vibration information.

The vibration information identified by the electronic device may include information on the time required from a time point at which the electronic device recognizes the second gesture to a time point at which the electronic device generates vibration according to vibration feedback generated according to the recognition of the second gesture. The vibration information may include information on a length of vibration (e.g., the time taken for one vibration) according to the vibration feedback based on the recognition of the second gesture. For example, the vibration information may include information indicating that 1 second is taken from the time point at which the electronic device recognizes the second gesture of the user to the time point at which the electronic device generates the vibration according to the vibration feedback, and include information indicating that the length of vibration according to the vibration feedback generated according to the recognition of the second gesture is 0.5 seconds.

In an embodiment, when the identified vibration information is information related to the vibration corresponding to the recognized second gesture, the electronic device may calculate, as the expected vibration section, a preset period of time from the time point at which the second gesture is recognized. Here, the electronic device may set the preset time as time (e.g., 1.5 seconds) obtained by summing the time taken from the time point at which the second gesture is recognized to the time point at which the vibration according to the vibration feedback is generated (e.g., 1 second) and the length of the vibration (e.g., 0.5 seconds).

In an embodiment, the electronic device may generate the vibration according to an alarm for an event occurring in the electronic device. In such a case, the electronic device may identify information related to the alarm for the event as the vibration information.

The vibration information identified by the electronic device may include information on a vibration period and a vibration length for the alarm. For example, the vibration information may include information indicating that the vibration period for the alarm is 3 seconds and the vibration length is 0.4 seconds.

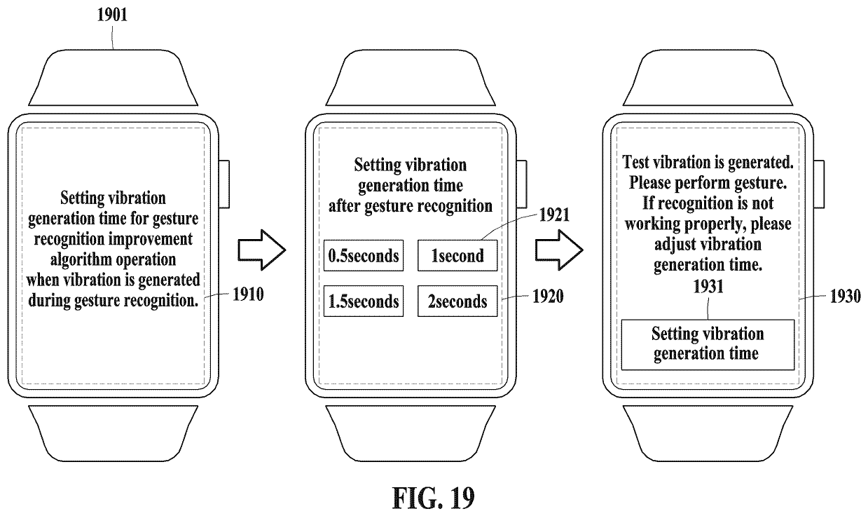

In an embodiment, when the identified vibration information is information related to the alarm for the event, the electronic device may calculate the expected vibration section using the vibration period and the vibration length extracted from the identified vibration information. For example, the vibration period of a vibration alarm may represent the time from the start of previous vibration to the start of next vibration. Therefore, the electronic device may set a section during the vibration period extracted from an end point of the previous vibration section as the expected vibration section. For example, the previous vibration section may be from a time point A to a time point B, and the vibration period may be 3 seconds. The electronic device may set, as the expected vibration section, a section for 3 seconds, which is the vibration period from the time point B, which is the end point of the previous vibration period. In another example, the electronic device may identify the vibration information that is changed by the user in real time. The identification of the vibration information based on the user input by the electronic device will be described in greater detail with reference to FIG. 19 below.

In operation 1822, the electronic device may calculate the vibration section using the sensor signal within the set expected vibration section. As described above, directly calculating the vibration section within the entire signal section may be inefficient in terms of data processing because the amount of data to be processed is relatively large. Therefore, the electronic device may efficiently process data by first calculating the expected vibration section within the entire signal section and then calculating the vibration section within the expected vibration section.

Referring to the graphs 1601 and 1602 of FIG. 16, the vibration in the electronic device and the gesture of the user may occur at intervals from each other. The electronic device may first calculate the expected vibration section and then calculate the vibration section from the expected vibration section. The electronic device may calculate a time section during which a first signal obtained from a first sensor exceeds a first threshold value within the expected vibration section, and calculate a time section during which a second signal obtained from a second sensor is less than a second threshold value within the calculated time section as the vibration section.

Hereinafter, a method of calculating the expected vibration section first and calculating the vibration section from the expected vibration section by the electronic device when the vibration in the electronic device and the gesture of the user occur adjacent to each other will be described in greater detail with reference to FIGS. 20 and 21.

In operation 1823, the electronic device may perform a process of suppressing or reducing a signal size of the detected vibration section.

FIG. 19 is a diagram illustrating an example process of changing time taken from a time point at which an electronic device recognizes a gesture based on a user input to a time point at which the electronic device generates vibration according to recognition of the gesture according to various embodiments.

In an embodiment, an electronic device 1901 (e.g., the electronic device 101 of FIG. 1, the electronic device 200 of FIG. 2A, the electronic device 300 of FIG. 3, or the electronic device 1401 of FIG. 14) may provide information 1910 for setting vibration information to a user. For example, the electronic device 1901 may output the information 1910 indicating “Setting vibration generation time for gesture recognition improvement algorithm operation when vibration is generated during gesture recognition” on a display (e.g., the display 220 of FIG. 3). After outputting the information 1910, the electronic device 1901 may provide the user with a user interface (UI) 1920 that allows the user to change vibration information settings. For example, the electronic device 1901 may provide a plurality of items 1921 that may change the vibration generation time on the UI 1920 in order to change a start time point of haptic vibration that is generated to notify the user that the electronic device 1901 has recognized the gesture of the user. For example, the user may set the time for which the vibration is generated from a gesture recognition time point as one of 0.5 seconds, 1 second, 1.5 seconds, or 2 seconds among the plurality of items 1921 provided by the electronic device 1901. The electronic device 1901 may identify the vibration information based on a change in vibration information input by the user (e.g., changing the vibration generation time to 1 second after the gesture recognition). At this time, the electronic device 1901 may provide the user with information 1930 on the vibration information changed by the user. When the user determines that the electronic device 1901 does not recognize the gesture properly based on the changed vibration information, the user may reset the vibration information based on a setting change UI 1931.

FIGS. 20 and 21 are a flowchart and graph illustrating an example process of calculating a boundary time point of a vibration signal and a gesture signal within an expected vibration section by an electronic device according to various embodiments.

FIGS. 20 and 21 illustrate an example process of calculating a boundary time point of a vibration signal and a gesture signal within an expected vibration section by an electronic device.

In an embodiment, an electronic device (e.g., the electronic device 101 of FIG. 1, the electronic device 200 of FIG. 2A, the electronic device 300 of FIG. 3, the electronic device 1401 of FIG. 14, or the electronic device 1901 of FIG. 19) may calculate a vibration section within an expected vibration section. The electronic device may calculate a boundary time point between a vibration signal and a gesture signal within the expected vibration section in order to calculate the vibration section. Hereinafter, the operation of calculating the vibration section using the sensor signal within the expected vibration section by the electronic device (e.g., operation 1822 of FIG. 18) will be described in greater detail.

In operation 2021 of FIG. 20, the electronic device may search for a reference time point at which a first signal value (e.g., a linear acceleration value) shows a maximum value within an expected vibration section 2131.

Referring to FIG. 21, a graph 2101 is a graph showing a first signal value (e.g., a linear acceleration value) at each time point measured by a first sensor (e.g., a linear acceleration sensor) of the electronic device. A graph 2102 is a graph showing a second signal value (e.g., an angular velocity value) for each time point measured by a second sensor (e.g., a gyro sensor) of the electronic device. Within the expected vibration section 2131, a gesture signal caused by performance of a gesture of a user and a vibration signal caused by generation of vibration in the electronic device may appear to overlap.

In an embodiment, the electronic device may calculate a detailed vibration search section 2132 within the expected vibration section 2131. The electronic device may calculate as the detailed vibration search section 2132, a section within the expected vibration section 2131, in which a first signal value (e.g., a linear acceleration value) measured by a first sensor (e.g., a linear acceleration sensor) exceeds a first threshold value and a second signal value (e.g., an angular velocity value) measured by a second sensor (e.g., a gyro sensor) is less than a second threshold value. The electronic device may search for a reference time point 2141 at which the first signal value (e.g., the linear acceleration value) shows a maximum value within the detailed vibration search section 2132.

In operation 2022, the electronic device may determine, as a section minimum time point, one time point of time points showing the first signal value having a ratio less than a first ratio with respect to the first signal value at the searched reference time point 2141.

Referring to FIG. 21, since the first signal value (e.g., the linear acceleration value) at the reference time point 2141 is a maximum value within the expected vibration section 2131, the reference time point 2141 may represent a peak time point of the vibration signal. The electronic device may determine the section minimum time point which is a boundary time point between the vibration signal and the gesture signal through unit tracking based on the reference time point 2141.

In an embodiment, the electronic device may determine, as a candidate minimum time point, a first time point 2161 showing the first signal value (e.g., the linear acceleration value) having a ratio less than the first ratio Bx with respect to the first signal value (e.g., the linear acceleration value) at the reference time point 2141. The first ratio Ba may have a value greater than 0 and less than 1. For example, the first ratio may be 0.5, but is not limited thereto.

In an embodiment, the electronic device may determine the section minimum time point by repeatedly updating the candidate minimum time point. In other words, the electronic device may determine a last updated candidate minimum time point as the section minimum time point.

In an embodiment, the electronic device may determine whether there is another time point at which the first signal value less than the first signal value (e.g., the linear acceleration value) at the first time point 2161 appears, after the first time point 2161 which is the candidate minimum time point. The electronic device may determine whether there is another time point in chronological order.

In an embodiment, during the operation of determining whether there is another time point, at which the first signal value less than the first signal value at the first time point 2161 which is the candidate minimum time point appears, the electronic device may search for a second time point 2162, at which the first signal value less than the first signal value at the first time point 2161 appears, and update the second time point 2162 as the candidate minimum time point when there is no first signal value having a ratio greater than or equal to a second ratio with respect to the first signal value at the first time point 2161, which is the candidate minimum time point, before the second time point 2162 is searched. Here, the second ratio may have a value greater than 1. For example, the second ratio may be 2, but is not limited thereto. In the same manner as above, the electronic device may repeatedly update the candidate minimum time point. For example, the electronic device may determine whether there is another time point, at which the first signal value less than the first signal value at the second time point 2162 appears, after the second time point 2162 which is the candidate minimum time point. During the operation of determining whether there is another time point, at which the first signal value less than the first signal value at the second time point 2162 which is the updated candidate minimum time point appears, the electronic device may search for a third time point 2163, at which the first signal value less than the first signal value at the second time point 2162 appears, and update the third time point 2163 as the candidate minimum time point when there is no linear acceleration value having a ratio greater than or equal to the second ratio $z with respect to the first signal value at the second time point 2162, which is the candidate minimum time point, before the third time point 2163 is searched.

In an embodiment, the electronic device may determine whether there is another time point, at which the first signal value less than the first signal value at the third time point 2163 appears, after the third time point 2163 which is the updated candidate minimum time point. In an embodiment, during the operation of determining whether there is another time point, at which the first signal value less than the first signal value at the third time point 2163 which is the updated candidate minimum time point, the electronic device may determine the third time point 2163 which is the candidate minimum time point as the section minimum time point, when the first signal value having a ratio greater than or equal to the second ratio 2 with respect to the first signal value at the third time point 2163 which is the candidate minimum time point, before another time point is searched.

In operation 2023, the electronic device may calculate the determined section minimum time point as a boundary time point between the vibration signal and the gesture signal.

For example, the electronic device may calculate the third time point 2163, which is the determined section minimum time point, as the boundary time point between the vibration signal and the gesture signal. The electronic device may calculate, as the vibration section, a section 2133 from a time point 2151 at which the first signal value exceeds the first threshold value within the expected vibration section 2131 to a section minimum time point (e.g., the third time point 2163) that is the boundary time point between the vibration signal and the gesture signal.

The time point 2151 at which the first signal value exceeds the first threshold value may be the same as a start point of the detailed vibration search section 2132. In other words, the electronic device may calculate the section 2133 from the start point of the detailed vibration search section 2132 to the section minimum time point (e.g., the third time point 2163) as the vibration section.

Since the boundary time point between the vibration signal and the gesture signal determined in the above manner is calculated and the section 2133 is calculated as the vibration section, the section in which the gesture signal is determined to be valid within the detailed vibration search section 2132 may be preserved. When the electronic device does not perform an operation of calculating the boundary time point 2163 within the detailed vibration search section 2132, downscaling may be performed on a signal included within the detailed vibration search section 2132. In this case, since the section in which the gesture signal is valid is included within the detailed vibration search section 2132, a portion of the gesture signal may also be downscaled, which may cause a distortion of the gesture signal. In other words, the electronic device may effectively process the vibration signal while minimizing/reducing a distortion of the gesture signal by calculating the vibration section (e.g., the section 2133) through the boundary time point 2163 between the vibration signal and the gesture signal and downscaling the signal included in the vibration section (e.g., the section 2133). Hereinafter, the process of downscaling the signal included in the vibration section 2133 by the electronic device will be described in greater detail.

In an embodiment, the electronic device may downscale a magnitude of the signal included in the calculated vibration segment (e.g., the section 2133) by a preset ratio or a preset value. For example, the preset ratio may be 10%, and the preset value may be 3, but these are not limited thereto.

In an embodiment, the electronic device may downscale only a sensor signal, in which the vibration signal appears, among sensor signals generated from a plurality of sensors. For example, according to a vibration frequency of the vibration, the vibration signal may not appear in a second signal obtained from a second sensor (e.g., an angular velocity signal of a gyro sensor or a PPG signal of a PPG sensor), but may appear in a first signal obtained from a first sensor (e.g., a linear acceleration signal of a linear acceleration sensor). Therefore, the electronic device may apply the downscaling only to the first signal (e.g., the linear acceleration signal) generated by the first sensor (e.g., the linear acceleration sensor).

In an embodiment, the electronic device may remove a signal included in the vibration segment (e.g., the section 2133). In other words, the electronic device may perform nulling, which changes the size of the signal included in the vibration section (e.g., the section 2133) to 0. The nulling method may be effective in processing vibration signals because it completely removes signals included in the vibration section (e.g., the section 2133) that mainly includes vibration signals. However, the nulling may cause side effects because it may make the signal discontinuous and the nulled section itself may be seen as a feature of the signal. More specifically, the electronic device may perform an FFT on the sensor signal to extract a Fourier coefficient in order to extract a feature in a frequency domain. When extracting the Fourier coefficient, the nulled section may be determined as a discontinuous section, which may distort the feature of the sensor signal. Even for different gesture signals, zero padding due to the nulled section may be determined as the same feature, and a similarity between the different gesture signals may be calculated to be high. Because of these side effects, the downscaling method that reduces the effect of the sensor signals without discontinuities is preferred over nulling.

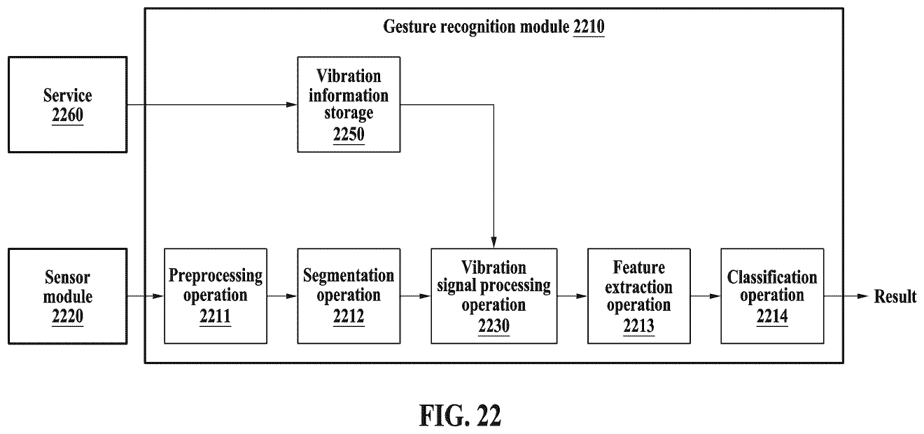

FIG. 22 is a diagram illustrating an example configuration and operation of a gesture recognition module of an electronic device according to various embodiments.

An electronic device according to an embodiment (e.g., the electronic device 101 of FIG. 1, the electronic device 200 of FIG. 2A, the electronic device 300 of FIG. 3, the electronic device 1401 of FIG. 14, or the electronic device 1901 of FIG. 19) may recognize a gesture of a user through a gesture recognition module 2210 (e.g., the gesture recognition module 1410 of FIG. 5). The gesture recognition module 2210 may receive a sensor signal from a sensor module 2220. The gesture recognition module (e.g., including various circuitry and/or executable program instructions) 2210 may process a vibration signal included in the received sensor signal.

In an embodiment, the gesture recognition module 2210 of the electronic device may identify vibration information. For example, the electronic device may identify, as the vibration information, one of information related to vibration corresponding to a second gesture recognized before a first gesture or information related to an alarm for an event occurring on the electronic device.

The gesture recognition module 2210 may load the vibration information from a vibration information storage 2250. The vibration information storage 2250 may receive the vibration information from a service 2260 that stores vibration information on vibration to be generated in response to a gesture or vibration information on an alarm. For example, the vibration information storage 2250 may receive the vibration information on vibration to be generated in response to the second gesture by communicating with the service 2260 at the time the second gesture is recognized, or may receive the information on the vibration information from the service 2260, store the information in advance, and then load the vibration information on the vibration to be generated in response to the second gesture. In another example, the vibration information storage 2250 may receive the vibration information on vibration according to an alarm to be generated by communicating with the service 2260 at the time an event generating the alarm occurs, or may receive the information on the vibration information from the service 2260, store the information in advance, and then load the vibration information on the vibration according to the alarm to be generated.

In an embodiment, the time point at which the gesture recognition module 2210 of the electronic device processes the vibration signal may vary.

For example, as illustrated in FIG. 22, the gesture recognition module 2210 of the electronic device may perform vibration signal processing operation 2230 after performing preprocessing operation 2211 and segmentation operation 2212. In other words, the gesture recognition module 2210 of the electronic device may perform preprocessing operation 2211 of preprocessing a sensor signal received from the sensor module 2220, and perform segmentation operation 2212 of generating a cropped time section for processing the vibration signal by cropping a valid signal section from the preprocessed sensor signal. The gesture recognition module 2210 of the electronic device may perform vibration signal processing operation 2230 of calculating the vibration section for the cropped time section and downscaling a signal included in the calculated vibration section. In addition, the electronic device may perform feature extraction operation 2213 of extracting a plurality of features from the signal section in which the vibration signal is processed, and classification operation 2214 of classifying a gesture signal using the plurality of extracted features.

In another example, the gesture recognition module 2210 of the electronic device may perform vibration signal processing operation 2230 before performing preprocessing operation 2211. In another example, the gesture recognition module 2210 of the electronic device may perform vibration signal processing operation 2230 between preprocessing operation 2211 and segmentation operation 2212.

Table 1 below shows advantages and disadvantages of the vibration signal processing operation 2230 depending on the timing of execution. Since preprocessing operation 2211 performs a function of removing a signal corresponding to a movement of the user other than the gesture of the user, it may be effective to perform vibration signal processing operation 2230 after preprocessing operation 2211 in order to accurately classify gesture signals in a situation with the movement of the user. In addition, since it is unnecessary to continuously process a vibration signal in a section where a gesture signal does not appear, it is efficient in terms of operation to perform vibration signal processing operation 2230 after extracting a valid signal section through segmentation operation 2212.

TABLE 1

| | | | |
|---|---|---|---|
| | When performing | When performing | When performing |
| | vibration signal | vibration signal | vibration signal |
| | processing operation | processing operations | processing |
| | after segmentation | between segmentation | operation before |
| | operation | operation and | preprocessing |
| | | preprocessing | operation |
| | | operation | |
| Advantages | Processing accuracy of | Processing accuracy of | Processing of |
| | vibration signal is high in | vibration signal is high | vibration signal |
| | situation with user | in situation with user | included in existing |
| | movement other than | movement other than | sensor signal is |
| | user gesture. | user gesture. | possible. |
| | It is efficient in terms of | | |
| | operation because | | |
| | processing operation of | | |
| | vibration signal is | | |
| | performed only when | | |
| | valid signal section is | | |
| | extracted. | | |
| Disadvantages | When performing | When performing | Processing accuracy |
| | preprocessing operation, | preprocessing | of vibration signal |
| | vibration signal may be | operation, vibration | may be reduced due |
| | dispersed, making it | signal may be | to movement of user |
| | difficult to completely | dispersed, making it | other than gesture. |
| | remove vibration signal. | difficult to completely | |
| | | remove vibration | |
| | | signal. | |

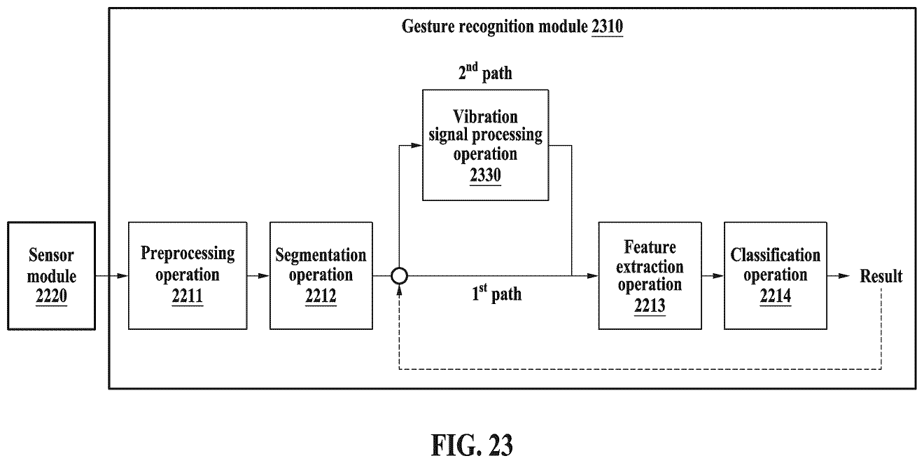

FIG. 23 is a diagram illustrating an example process in which an electronic device passively processes a vibration signal to prevent and/or reduce misclassification according to various embodiments.

Even if vibration signal processing operation 2330 suppresses the signal in a section where the vibration signal is dominant, a distortion of the gesture signal is unavoidable because the vibration signal is not completely separated and removed from the gesture signal. Such a distortion of the gesture signal may lead to worse results than a result of classifying the gesture signal without processing the vibration signal. In other words, if the vibration signal is not processed, the gesture signal might have been correctly classified, however, due to the processing of the vibration signal, the feature of the gesture signal may be further distorted, resulting in incorrect classification of the gestures. In order to address these problems, a passive processing method of a vibration signal is disclosed.

In an embodiment, the electronic device may perform classification on gesture signals included in a valid signal section without calculating a vibration section. Here, the valid signal section may represent a signal section obtained by performing preprocessing operation 2211 and segmentation operation 2212 on a sensor signal received from the sensor module 2220. The electronic device may not perform vibration signal processing operation 2230 for the valid signal section. The electronic device may determine whether a first classification result for the gesture signal in the valid signal section is classified as a preset gesture. Here, the preset gesture may be, for example, the OCO gesture or and the pinch gesture.

In an embodiment, when the first classification result for the gesture signal in the valid signal section, in which vibration signal processing operation 2330 is not performed, is not classified as the preset gesture, the electronic device may perform vibration signal processing operation 2330 to classify the gesture signals again. More specifically, when the first classification result is not classified as the preset gesture, the electronic device may perform the classification for the gesture signals in the valid signal section again based on performing vibration signal processing operation 2330 of calculating a vibration section in the valid signal section and downscaling a signal included in the calculated vibration section. The electronic device may calculate a final classification result using a second classification result for the gesture signal in the valid signal section. For example, the electronic device may calculate the second classification result as the final classification result. In another example, the electronic device may calculate final classification result by combining the first classification result and the second classification result.

A passive method of processing a vibration signal is to not process a vibration signal when a gesture signal is classified properly without processing the vibration signal, and to classify the gesture signal again after processing the vibration signal only when the gesture signal is not classified properly. The misclassification problem caused by the processing of the vibration signal may be prevented/reduced through the passive method of processing the vibration signal.

The various example embodiments described herein may be implemented using a hardware component, a software component and/or a combination thereof. A processing device may be implemented using one or more general-purpose or special-purpose computers, such as, for example, a processor, a controller and an arithmetic logic unit (ALU), a digital signal processor (DSP), a microcomputer, a field-programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and generate data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, or computer storage medium or device capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described embodiments may be recorded in non-transitory computer-readable media including program instructions to implement various operations of the above-described embodiments. The computer-readable media may also include, alone or in combination with the program instructions, data files, data structures, and the like. The program instructions recorded on the media may be those specially designed and constructed for the purposes of embodiments, or they may be of the kind well-known and available to those skilled in the computer software arts. Examples of non-transitory computer-readable media include magnetic media such as hard disks, floppy disks, and magnetic tape, optical media such as compact disc read-only memory (CD-ROM) discs and digital video discs (DVDs), magneto-optical media such as floptical disks, and hardware devices that are specifically configured to store and perform program instructions, such as ROM, random access memory (RAM), flash memory, and the like. Examples of program instructions include both machine code, such as produced by a compiler, and files containing higher-level code that may be executed by the computer using an interpreter. The above-described hardware devices may be configured to act as one or more software modules in order to perform the operations of the above-described embodiments, or vice versa.

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device comprising:
an actuator configured to generate vibration;
a plurality of sensors comprising a first sensor and a second sensor configured to recognize a gesture of a user of the electronic device;
a memory configured to store instructions; and
at least one processor, comprising processing circuitry, operatively connected to the actuator, the plurality of sensors, and the memory,
wherein at least one processor, individually and/or collectively, is configured to execute the instructions and to cause the electronic device to:
based on a first frequency, at which vibration is generated in a first signal obtained from the first sensor matching a vibration frequency range corresponding to the actuator, suppress and/or reduce a component of the first frequency in the first signal to provide a processed first signal; and
recognize a first gesture based on at least the processed first signal and a second signal obtained from the second sensor among a plurality of signals obtained from the plurality of sensors.

2. The electronic device of claim 1, wherein, based on the first sensor corresponding to a three-axis angular velocity sensor,
at least one processor, individually and/or collectively, is configured to cause the electronic device to:
based on a frequency component corresponding to the first frequency in a first-axis angular velocity signal obtained from the first-axis angular velocity sensor among the three-axis angular velocity sensor being less than a specified threshold value, and
frequency components corresponding to the first frequency respectively in a second-axis angular velocity signal obtained from a second-axis angular velocity sensor and a third-axis angular velocity signal obtained from a third-axis angular velocity sensor being greater than or equal to a specified threshold value,
determine that vibration of the electronic device is generated.

3. The electronic device of claim 2, wherein at least one processor, individually and/or collectively, is configured to cause the electronic device to:
store a frequency corresponding to a maximum value among frequency components in a frequency domain of the first-axis angular velocity signal as a first-axis candidate vibration frequency,
store a frequency corresponding to a maximum value among frequency components in a frequency domain of the second-axis angular velocity signal as a second-axis candidate vibration frequency,
store a frequency corresponding to a maximum value among frequency components in a frequency domain of the third-axis angular velocity signal as a third-axis candidate vibration frequency, and
suppress and/or reduce the first signal based on comparison results between each of the first-axis candidate vibration frequency, the second-axis candidate vibration frequency, and the third-axis candidate vibration frequency, and a vibration frequency range corresponding to the actuator.

4. The electronic device of claim 1, wherein at least one processor, individually and/or collectively, is configured to cause the electronic device to:
suppress and/or reduce the first signal by filtering in frequency components of the frequency domain less than the first frequency among frequency components of the first signal and filtering out frequency components of a frequency domain greater than or equal to the first frequency.

5. The electronic device of claim 1, wherein at least one processor, individually and/or collectively, is configured to cause the electronic device to:
extract an envelope signal corresponding to the second signal, and suppress and/or reduce the first signal based on the extracted envelope signal.

6. The electronic device of claim 5, wherein at least one processor, individually and/or collectively, is configured to cause the electronic device to:
suppress and/or reduce the first signal by applying the extracted envelope signal to the first signal.

7. The electronic device of claim 5, wherein at least one processor, individually and/or collectively, is configured to cause the electronic device to:
smooth the extracted envelope signal.

8. The electronic device of claim 5, wherein at least one processor, individually and/or collectively, is configured to cause the electronic device to:
extract another envelope signal corresponding to the first signal, and generate a combined envelope signal obtained by combining the extracted envelope signal and the other envelope signal, and
suppress and/or reduce each of the first signal and the second signal based on the generated combined envelope signal.

9. The electronic device of claim 8, wherein at least one processor, individually and/or collectively, is configured to cause the electronic device to:
suppress and/or reduce each of the first signal and the second signal by applying the combined envelope signal to each of the first signal and the second signal.

10. The electronic device of claim 1, wherein at least one processor, individually and/or collectively, is configured to cause the electronic device to:
identify vibration information related to vibration of the electronic device, based on the first sensor corresponding to a three-axis acceleration sensor, suppress and/or reduce a data size of a vibration section determined based on the vibration information in the first signal, and
recognize the first gesture based on the processed first signal and the second signal among the plurality of signals obtained from the plurality of sensors.

11. The electronic device of claim 10, wherein the vibration information includes one of information related to vibration temporarily generated by a second gesture recognized before the recognized first gesture or information related to vibration periodically generated by an event occurring in the electronic device.

12. The electronic device of claim 10, wherein the vibration information includes a control signal applied to the actuator and/or information identified by the at least one processor for generation of the vibration.

13. The electronic device of claim 10, wherein the vibration section is calculated from at least one of a vibration pattern, a vibration period, a vibration length, and a vibration time included in the identified vibration information.

14. The electronic device of claim 10, wherein the vibration section includes a section calculated based on the first signal and the second signal.

15. The electronic device of claim 10, wherein at least one processor, individually and/or collectively, is configured to cause the electronic device to:
calculate, as the vibration section, a time section in which the second signal is less than a second threshold value, within a time section in which the first signal exceeds a first threshold value.

16. The electronic device of claim 10, wherein at least one processor, individually and/or collectively, is configured to cause the electronic device to:
calculate an expected vibration section based on the identified vibration information, and
calculate the vibration section using a signal within the calculated expected vibration section.

17. The electronic device of claim 10, wherein at least one processor, individually and/or collectively, is configured to cause the electronic device to:
downscale a size of data included in the determined vibration section by a specified ratio or a specified value.

18. The electronic device of claim 10, wherein at least one processor, individually and/or collectively, is configured to cause the electronic device to:
preprocess a signal received from a sensor module, crop a valid signal section from the preprocessed signal, and calculate the vibration section for the cropped signal section.

19. The electronic device of claim 10, wherein at least one processor, individually and/or collectively, is configured to cause the electronic device to:
classify a gesture signal without calculating the vibration section, and based on a result of the classifying not being classified as a specified gesture, classify the gesture signal based on performing calculating the vibration section and downscaling data included in the calculated vibration section.

20. A method of operating an electronic device, the method comprising:
based on a first frequency, at which vibration is generated in a first signal obtained from a first sensor matching a vibration frequency range corresponding to an actuator, suppressing and/or reducing a component of the first frequency in the first signal to provide a processed first signal; and
recognizing a first gesture based on at least the processed first signal and a second signal obtained from a second sensor among a plurality of signals obtained from a plurality of sensors comprising the first sensor and the second sensor.
